(19) United States
(12) Patent Application Publication
(10) Pub. No.: US 2026/0277146 A1
(43) Pub. Date: Sep. 17, 2026

(54) CONVEYING DEVICE AND IMAGE FORMING APPARATUS

(71) Applicant: Ryohsuke TAWARA, Tokyo (JP)

(72) Inventor: Ryohsuke TAWARA, Tokyo (JP)

(73) Assignee: ETRIA CO., LTD., Yokohama-shi (JP)

(21) Appl. No.: 19/549,600

(22) Filed: Feb. 25, 2026

(30) Foreign Application Priority Data
Mar. 13, 2025 (JP) 2025-040584

(51) Int. Cl. G03G 15/00

(52) U.S. Cl. CPC G03G 15/6511; G03G 2215/004; G03G 2215/00679; G03G 2215/00734; G03G 2215/00738; G03G 2215/00746

(57) ABSTRACT

A conveying device includes a conveyor, a separator, a supplier, and circuitry. The conveyor conveys, at a conveyance speed, an object having a length, a width, and a thickness. The separator separates the object from a stack of objects, including the object, stacked to a stacking amount. The supplier supplies the object to the conveyor. The sensor detects the object floated from the stack of objects. The circuitry is to acquire the length, and at least one of the width, the thickness, the conveyance speed, or the stacking amount, determine a detection distance from the sensor to the object floated based on the length, and at least one of the width, the thickness, the conveyance speed, and the stacking amount acquired, set the detection distance to the sensor to detect the object floated, and detect the object floated by the sensor set at the detection distance determined.

### CROSS-REFERENCE TO RELATED APPLICATION

This patent application is based on and claims priority pursuant to 35 U.S.C. § 119(a) to Japanese Patent Application No. 2025-040584, filed on Mar. 13, 2025, in the Japan Patent Office, the entire disclosure of which is hereby incorporated by reference herein.

### BACKGROUND

### Technical Field

The present invention relates to a conveying device, and an image forming apparatus.

### Related Art

Various conveying devices in the art that convey a conveyance object such as a document or a sheet are known to have a technique for preventing occurrence of tearing in document when separating each document in a case where the document to be fed is a document (bound document) bound by staples. In such a technique, floating of the document when separating the document is detected using a distance sensor.

A conveying device in the art discloses that, when outputs of multiple ranging sensors are compared with a threshold value and a bound document is discriminated from a document in which folding or curling occurs, the threshold value is changed according to a length (document length) of the document in a conveyance direction.

However, according to the technique of the conveying device in the art, since floating of the document is detected using the document length, there has been a problem that the floating cannot be detected according to a difference in other features (width, thickness, conveyance speed, and loading amount) of the document.

### SUMMARY

Embodiments of the present disclosure described herein provide a novel conveying device including a conveyor, a separator, a supplier, a sensor, and circuitry. The conveyor conveys, at a conveyance speed, an object having a length, a width, and a thickness. The separator separates, in a separation process, the object from a stack of objects, including the object, stacked to a stacking amount. The supplier supplies the object to the conveyor. The sensor detects the object floated from the stack of objects in the separation process by the separator. The circuitry is to acquire the length, and at least one of the width, the thickness, the conveyance speed, or the stacking amount, determine a detection distance from the sensor to the object floated from the stack of objects based on the length, and at least one of the width, the thickness, the conveyance speed, and the stacking amount acquired, set the detection distance to the sensor to detect the object floated from the stack of objects, and detect the object floated from the stack of objects by the sensor set at the detection distance determined.

Further, embodiments of the present disclosure described herein provide an image forming apparatus including the above-described conveying device, and an image forming device to form an image on the object conveyed by the conveying device.

Further, embodiments of the present disclosure described herein provide a conveying device including a conveyor, a separator, a supplier, a sensor, circuitry, and a communicator. The conveyor conveys, at a conveyance speed, an object having a length, a width, and a thickness. The separator separates, in a separation process, the object from a stack of objects, including the object, stacked to a stacking amount. The supplier supplies the object to the conveyor. The sensor detects the object floated from the stack of objects in the separation process by the separator. The circuitry is to acquire information including the length, and at least one of the width, the thickness, the conveyance speed, or the stacking amount. The communicator sends the information acquired, to an external system, and receives, from the external system, at least one of a detection distance or a detection height to set the sensor to detect the object floated from the stack of objects. The external system determines at least one of the detection distance or the detection height based on the length and at least one of the width, the thickness, the conveyance speed, and the stacking amount acquired.

Further, embodiments of the present disclosure described herein provide an image forming apparatus including a conveyor, a separator, a supplier, an image forming device, and circuitry. The conveyor conveys, at a conveyance speed, an object having a length, a width, and a thickness. The separator separates, in a separation process, the object from a stack of objects, including the object, stacked to a stacking amount. The supplier supplies the object to the conveyor. The image forming device forms an image on the object supplied by the supplier. The circuitry is to acquire the length, and at least one of the width, the thickness, the conveyance speed, or the stacking amount, determine a detection distance from a sensor to the object floated from the stack of objects based on the length, and at least one of the width, the thickness, the conveyance speed, and the stacking amount acquired, and determine the detection distance based on the length, and at least one of the width, the thickness, the conveyance speed, and the stacking amount acquired.

According to the present disclosure, it is possible to detect floating of a conveyance object according to multiple features of the conveyance object to be conveyed.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram illustrating an example of an image forming apparatus;

FIG. 2 is an enlarged partial configuration diagram illustrating a part of an internal configuration of an image forming device;

FIG. 3 is a partially enlarged view of a part of a tandem portion;

FIG. 4 is a perspective view illustrating an example of a scanner and an ADF;

FIG. 5 is an enlarged configuration diagram illustrating a substantial configuration of the ADF and an upper part of the scanner;

FIG. 6 is a top view of the ADF;

FIGS. 7A and 7B are enlarged views of a part of a separating and feeding part of the ADF;

FIGS. 8A and 8B are enlarged views illustrating a part of a touch panel of an operation unit;

FIG. 9 is a perspective view illustrating an example of the ADF including a floating detection sensor;

FIG. 10 is a diagram illustrating an example of detection of floating of a bound document;

FIGS. 11A and 11B are diagrams for explaining an example of the floating detection sensor;

FIGS. 12A and 12B are diagrams illustrating an example of changing a detection height;

FIG. 13 is a block diagram illustrating a part of an electric circuit of an image forming apparatus according to a first embodiment;

FIG. 14 is a diagram illustrating an example of functional blocks of a controller according to the first embodiment;

FIG. 15 is a diagram for explaining generation of a trained model according to the first embodiment;

FIGS. 16A and 16B are diagrams illustrating an example of a detection distance and a detection height used for floating detection;

FIGS. 17A, 17B, 17C and 17D are diagrams illustrating an example of teacher data;

FIGS. 18A and 18B are other diagrams illustrating an example of a detection distance and a detection height used for floating detection;

FIGS. 19A and 19B are diagrams illustrating a difference in a floating characteristic depending on a document width;

FIG. 20 is a diagram illustrating another example of teacher data;

FIG. 21 including FIGS. 21A, 21B, 21C and 21D is a diagram illustrating another example of teacher data;

FIG. 22 is a flowchart illustrating an example of detection processing according to the first embodiment;

FIG. 23 is a diagram illustrating an example of functional blocks of a controller according to a second embodiment;

FIG. 24 is a diagram illustrating an example of time-series data of a voltage output from the floating detection sensor;

FIG. 25 is a diagram illustrating a state in which floating of a bound document is detected;

FIG. 26 including parts (a), (b) and (c) is a diagram illustrating a state in which a hand crosses an irradiation range of the floating detection sensor;

FIG. 27 is a diagram illustrating a state in which a shielding object is placed in the irradiation range of the floating detection sensor;

FIG. 28 including parts (a) and (b) is a diagram illustrating a state in which a shielding object is removed after feeding of the original document is started;

FIG. 29 including parts (a), (b) and (c) is a diagram illustrating a state in which a hand crosses an irradiation range of a floating detection sensor after feeding of a document is started;

FIGS. 30A, 30B, 30C, 30D and 30E are diagrams illustrating an example of teacher data using a combination of document information and time-series data of voltage;

FIG. 31 is a flowchart illustrating an example of detection processing according to a second embodiment;

FIG. 32 is a block diagram illustrating a part of an electric circuit of an image forming apparatus according to a second embodiment;

FIG. 33 is a diagram for explaining generation of a trained model according to the first embodiment;

FIG. 34 is a diagram illustrating an example of functional blocks of a controller according to the second embodiment;

FIG. 35 including parts (a) and (b) is a diagram illustrating a state in which a receipt document is fed to an ADF;

FIG. 36 is a flowchart illustrating an example of document conveyance processing according to a fourth embodiment;

FIG. 37 is a diagram illustrating an example of functional blocks according to a fifth embodiment;

FIGS. 38A and 38B are flowcharts illustrating an example of correction processing according to the fifth embodiment; and

FIG. 39 is a perspective view illustrating an example of an ADF according to the fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Embodiments of a conveying device, an image forming apparatus, a conveying method, and a program will be hereinafter described in detail with reference to the accompanying drawings.

### First Embodiment

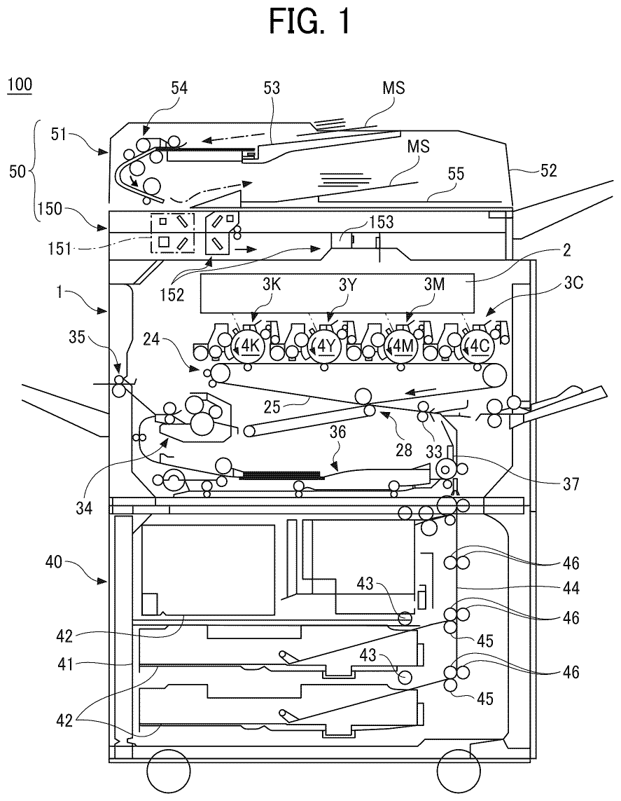

FIG. 1 is a schematic configuration diagram illustrating an example of an image forming apparatus 100.

The image forming apparatus 100 includes an image forming device 1, a sheet feeding device 40, and an image reading system 50. The image reading system 50 includes a scanner 150 as an image reading device that is fixed on the image forming device 1, and an automatic document feeder (ADF) 51 as a conveying device supported by the same. A case where the image forming apparatus 100 according to the present invention is applied to a multifunction peripheral (MFP) will be described as an example, but the present invention is not limited thereto. The multifunction peripheral is a device having at least two functions among a copy function, a scanner function, a facsimile (FAX) function, and a printer function.

The sheet feeding device 40 includes two sheet cassettes 42 arranged in multiple stages in a paper bank 41, a feed roller 43 that feeds a recording sheet from the sheet cassette, and a separation roller 45 that separates the fed recording sheets. Multiple conveyance roller pairs 46 each of which conveys the recording sheet to a sheet conveyance path 37 as a conveyance path in the image forming device 1 is also included. The recording sheet is an example of a conveyance object.

The sheet cassette 42 contains multiple recording sheets overlapping each other in a form of a sheet bundle. The feed roller 43 is pressed against an uppermost recording sheet. As the feed roller 43 rotates, the uppermost recording sheet of the sheet bundle is fed from the sheet cassette 42.

In the vicinity of the sheet cassette 42, a first conveyance roller and a second conveyance roller disposed lateral to the same (right side in FIG. 1) of the conveyance roller pair 46 are in contact with each other to form a conveyance nip region.

The separation roller 45 is disposed below the first conveyance roller and is in contact with the first conveyance roller from below to form a separation conveyance nip region.

The recording sheet fed from the sheet cassette 42 driven and rotated by the feed roller 43 enters the separation conveyance nip region formed by the contact of the first conveyance roller of the conveyance roller pair 46 and the separation roller 45 disposed below the same. In the separation conveyance nip region, the first conveyance roller that is in contact with an upper face of the recording sheet applies a conveyance force to the recording sheet from the sheet cassette 42 toward a sheet feeding path 44 as the first conveyance roller is driven and rotated in the counterclockwise direction in FIG. 1. In contrast, the separation roller 45 that is in contact with a lower face of the recording sheet applies a conveyance force to the recording sheet from the sheet feeding path 44 toward the sheet cassette 42 as the separation roller 45 is driven and rotated in the counterclockwise direction in FIG. 1 so as to return the recording sheet to the sheet cassette 42.

In a case where only one recording sheet is fed from the sheet cassette 42, the first conveyance roller and the separation roller 45 apply the conveyance force to the recording sheet in opposite directions to each other in the separation conveyance nip region. As a result, a load exceeding a given threshold value is applied to a drive transmission system of the separation roller 45. Then, a torque limiter disposed in the drive transmission system is operated to cut off the transmission of the driving force from a DC brushless motor to the separation roller 45. Accordingly, the separation roller 45 is rotated with the recording sheet that is conveyed by the first conveyance roller, and the recording sheet is ejected from the separation conveyance nip region to the sheet feeding path 44.

In contrast, in a case where the multiple recording sheets are fed from the sheet cassette 42 in an overlapped state, the first conveyance roller applies the conveyance force to the uppermost recording sheet from the sheet cassette 42 toward the sheet feeding path 44 in the separation conveyance nip region. The uppermost recording sheet is fed from the separation conveyance nip region toward the sheet feeding path 44. In contrast, the separation roller 45 applies the conveyance force from the sheet feeding path 44 toward the sheet cassette 42 to the lower recording sheet, so that the lower recording sheet is reversed from the separation conveyance nip region toward the sheet cassette 42. Accordingly, in the separation conveyance nip region, the uppermost recording sheet is separated from other recording sheets so as to be fed alone to the sheet feeding path 44.

The recording sheet entering the sheet feeding path 44 enters the conveyance nip region of the conveyance roller pair 46 where the conveyance force is applied upward from below in the vertical direction. Accordingly, the recording sheet in the sheet feeding path 44 is conveyed toward the sheet conveyance path 37 of the image forming device 1.

The image forming device 1 includes an optical writing device 2, and four image forming units 3K, 3Y, 3M, and 3C. The image forming units 3K, 3Y, 3M, and 3C form black, yellow, magenta, and cyan (K, Y, M, and C) toner images, respectively.

A transfer unit 24, a sheet conveyance unit 28, a registration roller pair 33, a fixing device 34, a switchback device 36, and the sheet conveyance path 37 are also included. A light source such as a laser diode and a light emitting diode (LED) disposed in the optical writing device 2 is driven to irradiate four drum-shaped photoconductors 4K, 4Y, 4M, and 4C with laser light L. By this irradiation, electrostatic latent images are formed on the surfaces of the photoconductors 4K, 4Y, 4M, and 4C and developed into toner images through a given developing process.

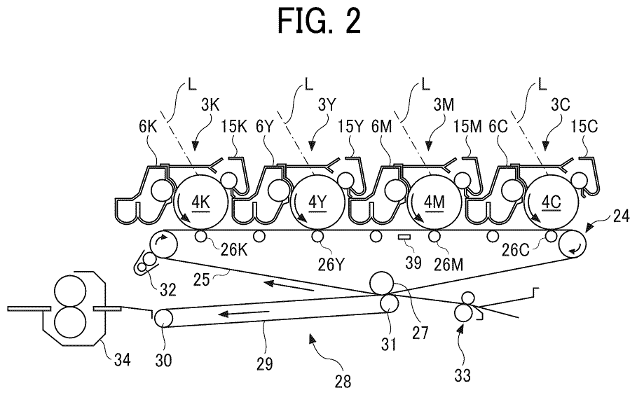

FIG. 2 is a partial configuration diagram illustrating a partially enlarged inner configuration of the image forming device 1.

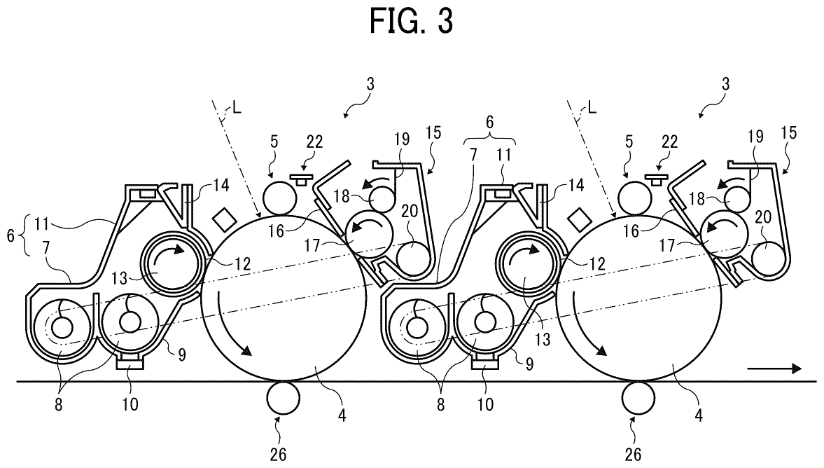

FIG. 3 is a partially enlarged view of a part of a tandem portion.

The tandem portion includes four image forming units 3K, 3Y, 3M, and 3C. Since the four image forming units 3K, 3Y, 3M, and 3C have respective configurations substantially similar to each other except the toner colors to be used, the image forming units 3K, 3Y, 3M, and 3C are also described without suffixes K, Y, M and C in FIG. 3.

Each of the image forming units 3K, 3Y, 3M, and 3C supports, by a common support member, the photoconductor and various devices arranged around the same as a single unit, and is detachably attached to the image forming device 1. For example, the image forming unit 3K for black includes the photoconductor 4, and a charging device 23, a developing device 6, a drum cleaning device 15, and an electric discharging lamp 22 around the photoconductor 4. The present embodiment has a tandem configuration in which the four image forming units 3K, 3Y, 3M, and 3C are arranged so as to face an intermediate transfer belt 25 to be described below in an endless movement direction thereof.

As the photoconductor 4, an element tube made of aluminum in a drum shape on which a photoconductive layer formed by applying an organic photoconductive material having photoconductivity is formed is used. The photoconductor 4 may have a shape of an endless belt.

The developing device 6 develops an electrostatic latent image using a two-component developer including magnetic carriers and non-magnetic toner. The developing device 6 includes an agitating portion 7 and a development portion 11. The agitating portion 7 stirs the two-component developer accommodated therein and conveys the two-component developer to a development sleeve 12. The development portion 11 transfers the toner included in the two-component developer held by the development sleeve 12 to the photoconductor 4.

The agitating portion 7 is located at a position lower than the development portion 11 and includes two transfer screws 8 arranged so as to be parallel to each other, a partition provided between the screws, and a toner concentration sensor 10 provided on a bottom surface of a development case 9.

The development portion 11 includes the development sleeve 12, a magnetic roller 13, and a doctor blade 14. The development sleeve 12 faces the photoconductor 4 through an opening of the development case 9. The magnetic roller 13 is unrotatably disposed inside the development sleeve 12. A leading end of the doctor blade 14 is disposed close to the development sleeve 12. The development sleeve 12 has a non-magnetic, rotatable tubular body. The magnetic roller 13 has multiple magnetic poles arranged in the order in a rotation direction of the sleeve, starting from a position facing the doctor blade 14. Each of these magnetic poles applies a magnetic force at a given position in the rotation direction with respect to the two-component developer on the sleeve. Accordingly, the two-component developer that is conveyed from the agitating portion 7 is attracted to the surface of the development sleeve 12 to be held and a magnetic brush is formed along a magnetic force line on the surface of the sleeve.

In accordance with rotation of the development sleeve 12, the magnetic brush is regulated to have an appropriate layer thickness when passing by the position facing the doctor blade 14. Then, the magnetic brush is conveyed to a development region facing the photoconductor 4. Due to a difference in potential between a development bias that is applied to the development sleeve 12 and an electrostatic latent image on the photoconductor 4, the toner is transferred onto the electrostatic latent image to contribute to development. After returning into the development portion 11 again along with the rotation of the development sleeve 12, then leaving from the surface of the sleeve due to an influence of a repulsive magnetic field formed between the magnetic poles of the magnetic roller 13, the magnetic brush is returned to the agitating portion 7. An appropriate amount of toner is supplied to the two-component developer in the agitating portion 7 based on a result detected by the toner concentration sensor 10. Alternative to the two-component developer, the developing device 6 may employ one-component developer that does not include the magnetic carriers.

In the drum cleaning device 15, a system in which a cleaning blade 16 made of an elastic member is pressed against the photoconductor 4 is used, but another system may also be used. In order to improve a cleaning performance, the present embodiment employs a system in which a fur brush 17 of a conduct conductive type of which an outer peripheral surface is brought into contact with the photoconductor 4 is rotatable in a direction indicated by arrow in FIG. 3. The fur brush 17 also scrapes a lubricant from a solid lubricant to obtain fine powder of lubricant and applies the scraped fine powder to the surface of the photoconductor 4. An electric field roller 18 made of metal that applies a bias to the fur brush 17 is disposed rotatably in a direction indicated by arrow in FIG. 3, and a leading end of the scraper 19 is pressed against the same. The toner attached to the fur brush 17 is transferred onto the electric field roller 18 that comes into contact with the fur brush 17 and rotates in a counter direction to be applied with a bias. After being scraped from the electric field roller 18 by the scraper 19, the toner falls onto a collection screw 20. The collection screw 20 conveys the collected toner toward an end of the drum cleaning device 15 in a direction orthogonal to the drawing sheet, and transfers the collected toner to a recycling conveyor 21 that is an external toner recycling conveyor. The recycling conveyor 21 sends the transferred toner to the developing device 6 for recycling.

The electric discharging lamp 22 removes residual electric charge remaining on the surface of the photoconductor 4 by photo irradiation. The electrically discharged surface of the photoconductor 4 is uniformly charged by the charging device 23 and then subjected to optical writing processing by the optical writing device 2. The charging device 23 is a charging roller that is applied with charging bias and rotates while coming into contact with the photoconductor 4. A scorotron charger that performs charging processing on the photoconductor 4 in non-contact with the photoconductor 4 may be used.

In FIG. 2, black (K), yellow (Y), magenta (M), and cyan (C) toner images are formed on the photoconductors 4K, 4Y, 4M, and 4C of the four image forming units 3K, 3Y, 3M, and 3C, respectively, by the processes described heretofore.

The transfer unit 24 is disposed below the four image forming units 3K, 3Y, 3M, and 3C. The transfer unit 24 endlessly moves the intermediate transfer belt 25 stretched by and wound around multiple rollers in the clockwise direction in FIG. 2 while allowing the intermediate transfer belt 25 to be in contact with the photoconductors 4K, 4Y, 4M, and 4C. Accordingly, respective primary transfer nip regions for black (K), yellow (Y), magenta (M), and cyan (C) at which the photoconductors 4K, 4Y, 4M, and 4C and the endless intermediate transfer belt 25 are in contact with each other are formed. In the vicinity of the primary transfer nip regions for black (K), yellow (Y), magenta (M), and cyan (C), the primary transfer rollers 26K, 26Y, 26M and 26C disposed inside a belt loop press the intermediate transfer belt 25 against the photoconductors 4K, 4Y, 4M and 4C, respectively.

A primary transfer bias is applied by respective power supplies to the primary transfer rollers 26K, 26Y, 26M, and 26C. Accordingly, respective primary transfer electric fields are formed in the primary transfer nip regions for black (K), yellow (Y), magenta (M), and cyan (C) to electrostatically transfer respective toner images on the photoconductors 4K, 4Y, 4M, and 4C onto the intermediate transfer belt 25. Along with the endless rotation in the clockwise direction in FIG. 2, the toner images are sequentially overlaid to be primarily transferred at the primary transfer nip regions onto a front face of the intermediate transfer belt 25 that sequentially passes through the primary transfer nip regions for black (K), yellow (Y), magenta (M), and cyan (C). Due to the primary transfer of the overlaid toner images, a four-color composite toner image (hereinafter referred to as a four-color toner image) is formed on the front face of the intermediate transfer belt 25.

Below the transfer unit 24 in FIG. 2, the sheet conveyance unit 28 that endlessly moves an endless sheet transfer belt 29 wound between a drive roller 30 and a secondary transfer roller 31 is provided. The intermediate transfer belt 25 and the sheet transfer belt 29 are sandwiched between the secondary transfer roller 31 thereof and a lower tension roller 27 of the transfer unit 24. Accordingly, a secondary transfer nip region is formed at which the front face of the intermediate transfer belt 25 is in contact with a front face of the sheet transfer belt 29. A secondary transfer bias is applied by a power supply to the secondary transfer roller 31. In contrast, the lower tension roller 27 of the transfer unit 24 is electrically grounded. Accordingly, a secondary transfer electric field is formed in the secondary transfer nip region.

The registration roller pair 33 is disposed on a right side of the secondary transfer nip region in FIG. 2. A registration roller sensor is disposed adjacent to an entrance of the registration nip region of the registration roller pair 33. The recording sheet is conveyed from a sheet feeding device to the registration roller pair 33. After a given time has elapsed from the detection of the leading end of the recording sheet by the registration roller sensor, the conveyance of the recording sheet temporarily stops, and the leading end of the recording sheet is brought into contact with the registration nip region of the registration roller pair 33.

After the leading end of the recording sheet comes into contact with the registration nip region, the registration roller pair 33 restarts the roller rotation driving at a timing at which the movement of the recording sheet can be synchronized with the movement of the four-color toner image on the intermediate transfer belt 25, and conveys the recording sheet to the secondary transfer nip region. In the secondary transfer nip region, the four-color toner image on the intermediate transfer belt 25 is transferred onto the recording sheet in the secondary transfer at once due to the secondary transfer electric field and the nip pressure, and the four-color toner image is combined with white color of the recording sheet to make a full-color image. After passing through the secondary transfer nip region, the recording sheet is separated from the intermediate transfer belt 25, and while being held on the front face of the sheet transfer belt 29, the recording sheet is conveyed to the fixing device 34 along with endless movement of the sheet transfer belt 29.

Residual toner that has not been transferred onto the recording sheet in the secondary transfer nip region remains on the surface of the intermediate transfer belt 25 after the intermediate transfer belt 25 has passed through the secondary transfer nip region. The residual toner is scraped and removed by a belt cleaning device that is disposed in contact with the intermediate transfer belt 25.

After the full-color image is fixed to the recording sheet conveyed to the fixing device 34 by application of heat and pressure in the fixing device 34, the recording sheet is conveyed from the fixing device 34 to a sheet ejection roller pair 35 to be ejected to the outside of the image forming device 1.

As illustrated in FIG. 1, the switchback device 36 is disposed below the sheet conveyance unit 28 and the fixing device 34. As a result, after image fixing processing is performed on one side of the recording sheet, a switching claw switches a path of the recording sheet in a direction toward a recording sheet reversal device where the recording sheet is reversed to enter the secondary transfer nip region again. After subjected to the secondary transfer processing and the fixing processing of the image on the other side, the recording sheet is ejected onto an ejection tray.

A scanner 150 fixed onto the image forming device 1 includes a movable reading unit 152. The scanner 150 and the ADF 51 include fixed reading units, respectively. The movable reading unit 152 is disposed immediately below a second exposure glass that is fixed to an upper wall of a casing of the scanner 150 so as to be in contact with an original document MS. In the movable reading unit 152, an optical system including a light source and a reflection mirror can be moved in left and right directions in FIG. 1. In the course of moving the optical system from left to right in FIG. 1, after the original document loaded on the second exposure glass reflects the light emitted from the light source, the reflected light is further reflected on multiple reflection mirrors until an image reading sensor 153 that is fixed to the scanner 150 receives the reflected light. The original document MS is an example of a conveyance object.

In contrast, the fixed reading unit includes a first fixed reading unit 151 disposed inside the scanner 150, and a second fixed reading unit disposed inside the ADF 51. The first fixed reading unit 151 including the light source, the reflection mirror, and the image reading sensor such as CCD is disposed immediately below a first exposure glass that is fixed to the upper wall of the casing of the scanner 150 so as to be in contact with the original document MS. When the sheet-like original document MS that is conveyed by the ADF 51 to be described later passes over the first exposure glass, the light emitted by the light source is sequentially reflected by a document surface and further reflected on multiple reflection mirrors until the image reading sensor receives the reflected light. Accordingly, a first face of the original document MS is scanned without moving the optical system including the light source and the reflection mirror. The second fixed reading unit scans a second face of the original document MS after the original document MS passes through the first fixed reading unit 151.

In the ADF 51 disposed on the scanner 150, a body cover 52 holds a document loading tray 53 as a document loading unit for loading the original document MS to be read. A document conveyance unit 64 for conveying the original document MS as a sheet member, and a document stacking table 55 for stacking the original document MS after the original document MS is read are also held.

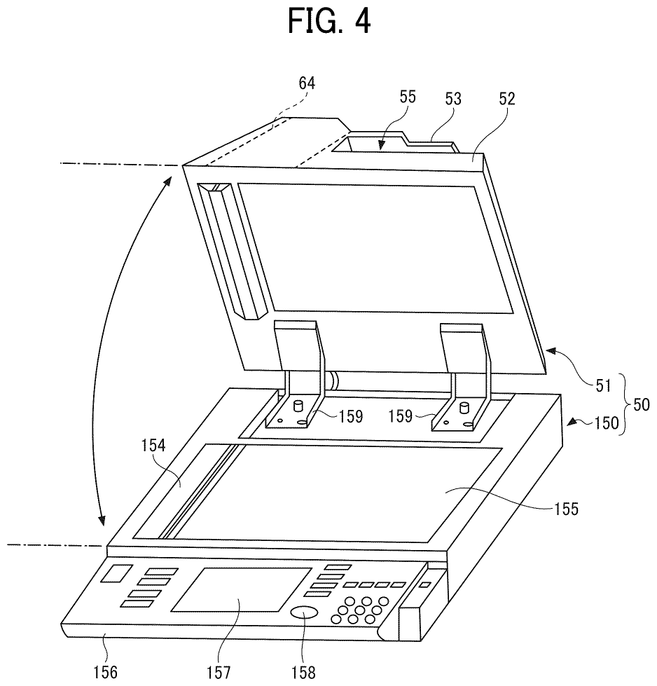

FIG. 4 is a perspective view illustrating an example of the scanner 150 and the ADF 51.

As illustrated in FIG. 4, the ADF 51 is supported by hinges 159 each being fixed to the scanner 150 so as to be pivotable in the vertical direction. With this pivoting, the ADF 51 works as an open-close door, so that the first exposure glass 154 and the second exposure glass 155 on an upper face of the scanner 150 are exposed while the ADF 51 is open. As illustrated in FIG. 4, an operation unit 156 of the scanner 150 includes a numeric keypad, a display (touch panel 157), and a start key 158. When the start key 158 is pressed by an operator, conveyance of the original document by the ADF 51 and reading of the original document by the scanner 150 are started.

In a case of one-sided bound documents such as a book of a document bundle bounded on one-side, the original documents cannot be separated one by one, so that they cannot be conveyed by the ADF 51. In a case of reading the one-sided bound documents, the ADF 51 is opened as illustrated in FIG. 4, and then the one-sided bound documents are placed on the second exposure glass 155 with a page to be read facing down, then the ADF 51 is closed. The movable reading unit 152 of the scanner 150 illustrated in FIG. 1 is caused to read the image on the page.

In contrast, in a case of the document bundle obtained by accumulating individual multiple original documents MS, the original documents MS can be sequentially read by the first fixed reading unit 151 in the scanner 150 or the second fixed reading unit in the ADF 51 while the ADF 51 automatically conveys the original documents MS one by one. In this case, a copy start button is pressed after the document bundle is set on the document loading tray 53.

Then, the ADF 51 conveys the original documents MS of the document bundle loaded on the document loading tray 53 sequentially from top to the document conveyance unit 64 one by one, and further conveys the same to the document stacking table 55 while reversing the same.

In the course of this conveyance, immediately after the original document MS is reversed, the original document MS is caused to pass immediately above the first fixed reading unit 151 of the scanner 150. At this time, the image on the first face of the original document MS is read by the first fixed reading unit 151 of the scanner 150.

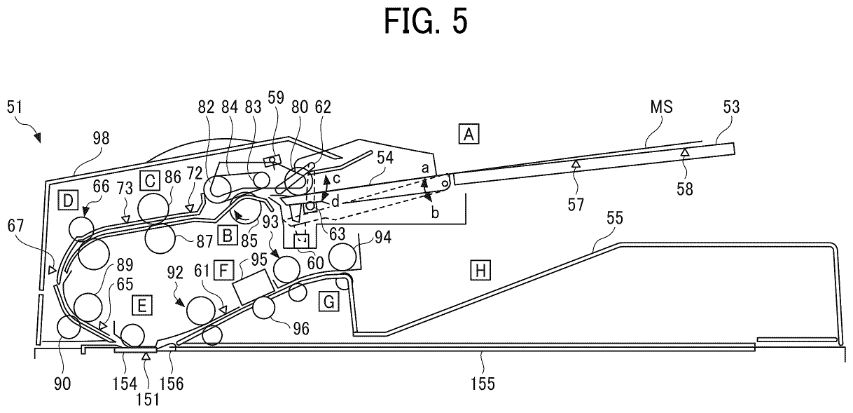

FIG. 5 is an enlarged configuration diagram illustrating a substantial configuration of the ADF 51 and an upper part of the scanner 150.

The ADF 51 includes a document setting part A, a separating and feeding part B, a registration part C, a turning part D, a first reading and conveying part E, a second reading and conveying part F, a document ejecting part G, and a stacking part H. The ADF 51 also includes a document conveyance path for conveying the original document MS from the document loading tray 53 toward the first fixed reading unit 151 that is an image reading position.

The document setting part A includes the document loading tray 53 on which a bundle of the original documents MS (bundle of conveyance objects) is placed. The separating and feeding part B feeds the original document MS one by one separately from the set bundle of the original documents MS. The separating and feeding part B is an example of a separator.

The registration part C temporarily comes into contact with the fed original documents MS to align and feed again the original documents MS. The registration part C is an example of a supplier that supplies the original document, which is an example of the conveyance object. The turning part D includes a curved conveying part curved in a C-shape, and turns the original document MS in the curved conveying part so as to reverse the original document MS upside down. The separating and feeding part B, the registration part C, and the turning part D are covered with an upper cover 98 of the ADF 51.

In the first reading and conveying part E, the first fixed reading unit 151 disposed in the scanner below the first exposure glass 154 reads the first face of the original document MS while the original document MS is being conveyed on the first exposure glass 154. In the second reading and conveying part F, the second fixed reading unit 95 reads the second face of the original document MS while the original document MS is conveyed under the second fixed reading unit 95. The document ejecting part G ejects the original document MS the images on both sides of which are read toward the stacking part H. In the stacking part H, the original documents MS are stacked on the document stacking table 55. Each of the first reading and conveying part E and the second reading and conveying part F is an example of a conveyor. The conveyance object in the present embodiment may be any object as long as the object is conveyed by the conveyance unit, and includes a sheet, a receipt, and a business card in addition to the recording sheet and the original document described above.

The original document MS is set with a leading end loaded on the movable document table 54 pivotable in directions indicated by arrows “a” and “b” in FIG. 5 depending on the thickness of the bundle of the original documents MS, and a trailing end loaded on the document loading tray 53. At this time, on the document loading tray 53, side guides are brought into contact with both ends in a width direction (the direction orthogonal to the drawing sheet) to adjust the position in the width direction. The original documents MS thus set push up a lever 62 that is pivotably disposed above the movable document table 54. Along with this, a document set sensor 63 detects the setting of the original documents MS, and sends a detection signal to a controller. The detection signal is sent from the controller to a reader controller of the scanner via an interface (I/F).

The document loading tray 53 holds a first length sensor 57 and a second length sensor 58 (hereinafter, sometimes collectively referred to as length sensors 57 and 58) that are a reflective photosensor or an actuator-type sensor for detecting a length of the original document MS in a conveyance direction thereof. The length (document length) of the original document MS in the conveyance direction is detected by these length sensors. A direction (width direction) orthogonal to the conveyance direction of the original document MS is referred to as a main-scanning direction, and the conveyance direction of the original document MS is referred to as a sub-scanning direction.

A pickup roller 80 supported by a cam mechanism to be movable in the vertical direction (the directions indicated by arrows “c” and “d” in FIG. 5) is disposed above the bundle of original documents MS loaded on the movable document table 54. The cam mechanism can be driven by a pickup motor 56 to move the pickup roller 80 in the vertical direction. As the pickup roller 80 moves upward, the movable document table 54 pivots in the direction indicated by arrow “a” in FIG. 5, so that the pickup roller 80 is brought into contact with the uppermost original document MS of the bundle of original documents MS. As the movable document table 54 further moves upward, an elevation detection sensor 59 detects that the movable document table 54 moves up to the upper limit. Accordingly, the pickup motor 56 stops to stop the movable document table 54 from moving up. At this time, a document loading amount can be estimated based on the time from when the elevation of the movable document table 54 is started until when it is detected that the movable document table 54 is elevated to the upper limit by the elevation detection sensor 59.

As for the operation unit 156, the operator performs a key operation for setting a reading mode indicating a double-sided reading mode or a single-sided reading mode, and a pressing operation of the start key 158. As the start key 158 is pressed, a document feeding signal is sent from a main body controller to the controller of the ADF 51. Then, the pickup roller 80 is driven and rotated along with forward rotation of a sheet feed motor 76, so that the original document MS on the movable document table 54 is fed from the movable document table 54.

The setting of the double-sided reading mode or the single-sided reading mode collectively covers the whole original documents MS loaded on the movable document table 54. The reading mode can be individually set for individual original documents MS. For example, the double-sided reading mode can be applied to the first and tenth original documents MS while the single-sided reading mode can be applied to the other original documents MS.

The original document MS fed by the pickup roller 80 enters the separating and feeding part B to be fed to a contact position with a sheet feed belt 84. The sheet feed belt 84 is wound and stretched by a drive roller 82 to be endlessly moved in the clockwise direction in FIG. 5 by rotation of the drive roller 82 along with the forward rotation of the sheet feed motor 76. A separation roller 85 is in contact with a lower stretched face of the sheet feed belt 84 to be driven and rotated in the clockwise direction in FIG. 5 along with the forward rotation of the sheet feed motor 76. At a contact portion, the surface of the sheet feed belt 84 moves in a sheet conveyance direction. In contrast, the separation roller 85 is in contact with the sheet feed belt 84 with a given pressure, and when this is in direct contact with the sheet feed belt 84, or a single original document MS is nipped in the contact portion, this is co-rotated with the belt or the original document MS. However, when multiple original documents MS are nipped in the contact portion, a co-rotation force is lower than torque of a torque limiter, so that the separation roller 85 is driven and rotated in the clockwise direction in FIG. 5 opposite to a co-rotating direction. As a result, the separation roller 85 applies the moving force in the direction opposite to the sheet conveyance direction to the original documents MS under the uppermost original document MS, so that only the uppermost original document MS is separated from the multiple original documents MS (the operation up to this point is hereinafter referred to as a sheet feeding/separating operation).

One original document MS separated by the operations of the sheet feed belt 84 and the separation roller 85 enters the registration part C. The leading end of the original document MS is detected when this passes directly under a contact sensor 72. At this time, the pickup roller 80 receiving the driving force of the pickup motor 56 is still driven and rotated; however, as the pickup roller 80 is separated from the original document MS when the movable document table 54 lowers, the original document MS is conveyed only by an endless moving force of the sheet feed belt 84. Then, the endless movement of the sheet feed belt 84 is continued for a given time from the timing at which the leading end of the original document MS is detected by the contact sensor 72. Accordingly, the leading end of the original document MS comes into contact with the contact portion between a pullout drive roller 86 and a pullout driven roller 87 that is driven to be rotated while being in contact with the pullout drive roller 86.

The pullout driven roller 87 has a function of conveying the original document MS to an intermediate roller pair 66 downstream in the document conveyance direction, and is driven and rotated by rotation of the sheet feed motor 76 in the reverse direction. As the sheet feed motor 76 rotates in the reverse direction, the pullout driven roller 87 and one roller of the intermediate roller pair 66 in contact with each other start rotating and the endless movement of the sheet feed belt 84 stops. At this time, the pickup roller 80 stops rotating.

The original document MS that is fed by the pullout driven roller 87 passes directly under the document width sensor 73. The document width sensor 73 includes multiple document detectors each including a reflective photosensor. The multiple document detectors are aligned in a document width direction (the direction orthogonal to the drawing sheet). The size of the original document MS in the width direction is detected based on which one of the document detectors detects the original document MS. The length of the original document MS in the conveyance direction is detected based on the time from when the leading end of the original document MS is detected by the contact sensor 72 to when the trailing end of the original document MS is not detected by the contact sensor 72 any more.

The leading end of the original document MS of which the size in the width direction is detected by the document width sensor 73 enters the turning part D and is nipped by the contact portion between the rollers of the intermediate roller pair 66. A conveyance speed of the original document MS by the intermediate roller pair 66 is set faster than a conveyance speed of the original document MS in the first reading and conveying part E to be described below. As a result, a reduction in time for conveying the original document MS to the first reading and conveying part E is implemented.

The leading end of the original document MS conveyed in the turning part D passes through a position where the leading end of the original document faces a scan entrance sensor 67. As a result, when the leading end of the original document MS is detected by the scan entrance sensor 67, the conveyance speed of the original document by the intermediate roller pair 66 is reduced until the leading end is conveyed to a position of the scan entrance roller pair (including rollers 89 and 90) downstream in the conveyance direction. As a document reading motor starts to drive and rotate, one roller of the scan entrance roller pair (including the rollers 89 and 90), one roller of a scan exit roller pair 92, and one roller of a second scan exit roller pair 93 respectively start rotation.

In the turning part D, while the original document MS is conveyed in the curved conveyance path between the intermediate roller pair 66 and the scan entrance roller pair (including the rollers 89 and 90), upper and lower faces of the original document MS are reversed, and the conveyance direction is turned back. Then, the leading end of the original document MS that has passed through the nip region between the rollers (including the rollers 89 and 90) of the scan entrance roller pair passes directly under the registration sensor 65. The operation up to this point after the sheet feeding and separating operation is referred to as a document pullout operation.

When the registration sensor 65 detects the leading end of the original document MS, the conveyance speed of the original document is gradually reduced through the given conveyance distance. The pullout drive roller 86 and the intermediate roller pair 66 stop being driven and rotated due to the stop of the sheet conveyance motor, and the scan entrance roller pair stops being driven and rotated due to the stop of the document reading motor. As a result, the conveyance of the original document MS is temporarily stopped at the registration position before the first reading and conveying part E. A registration stop signal is sent to the reader controller.

A method of acquiring the document width and the document thickness (hereinafter, referred to as a paper thickness or a document thickness) in the ADF 51 will be described.

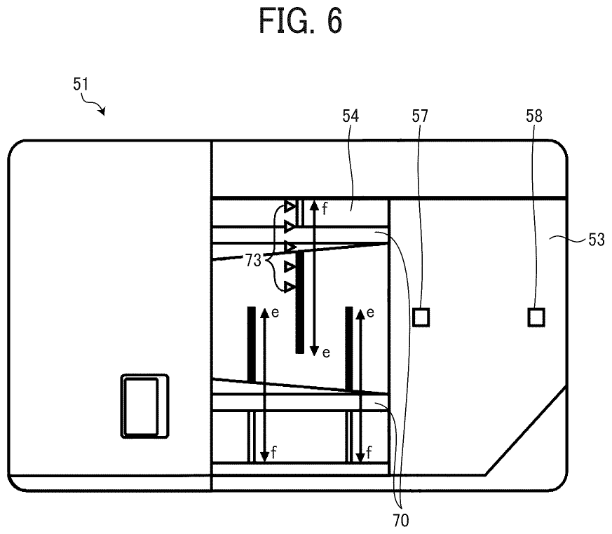

FIG. 6 is a top view of the ADF 51.

The original documents MS are loaded on the movable document table 54 with the width being aligned by the side fence 70 on the movable document table 54. The side fences 70 are provided at both ends of the movable document table 54, and when one moves with respect to the center, the other also moves in the same direction by the same distance in the directions indicated by arrows “e” and “f” in FIG. 6. A filler is attached to the back side of the side fence 70, and the document width is detected by the document width sensor 73 detecting the filler.

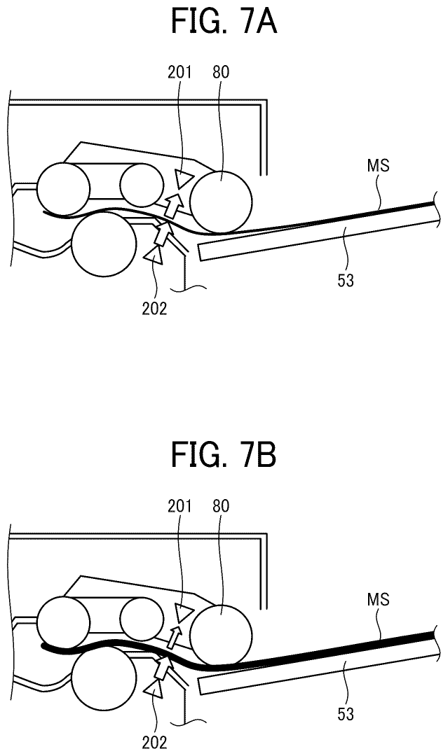

FIGS. 7A and 7B are partially enlarged views of the separating and feeding part B of the ADF 51.

The paper thickness can be acquired by an ultrasonic sensor 201 and an ultrasonic oscillator 202 attached downstream of the pickup roller 80. When an ultrasonic wave is oscillated from the ultrasonic oscillator 202, the ultrasonic wave passes through the document MS and reaches the ultrasonic sensor 201 for reception. At this time, the paper thickness is determined from an attenuation rate of the ultrasonic wave reaching the ultrasonic sensor 201 for reception. The determined paper thickness is, for example, thick paper, thin paper, or plain paper thickness. In a case of FIGS. 7A and 7B, it is determined as thin paper in FIG. 7A in which the attenuation rate of ultrasonic wave is small, and it is determined as thick paper in FIG. 7B in which the attenuation rate is large.

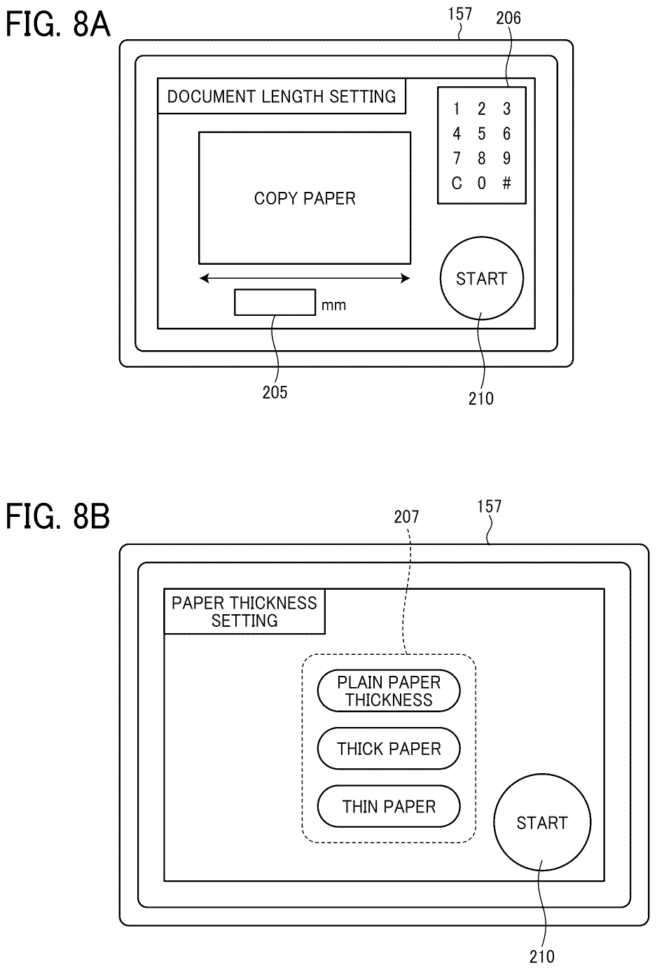

FIGS. 8A and 8B are enlarged views illustrating a part of the touch panel 157 of the operation unit 156.

Instead of being acquired by the detection by the sensor, the document length and the paper thickness may be acquired by the operator inputting data using the operation unit 156. The operation unit 156 may include a numeric keypad 206 and a start button 210 displayed on a touch panel 157 as illustrated in FIGS. 8A and 8B instead of including a physical numeric keypad and the start key 158.

As illustrated in FIG. 8A, the operator can input the document length into a document length input field 205 using a numeric keypad. As illustrated in FIG. 8B, the operator can input the paper thickness by selecting the paper thickness using a paper thickness selection button 207. The operator can start conveying the original document by inputting the document length and the paper thickness using the touch panel 157 and pressing the start button 210. The document length and the paper thickness may be acquired by detection by a sensor and may be acquired by the operator inputting data using the operation unit 156. In this case, in floating detection processing to be described later, if the operator has input the data, the data may be used.

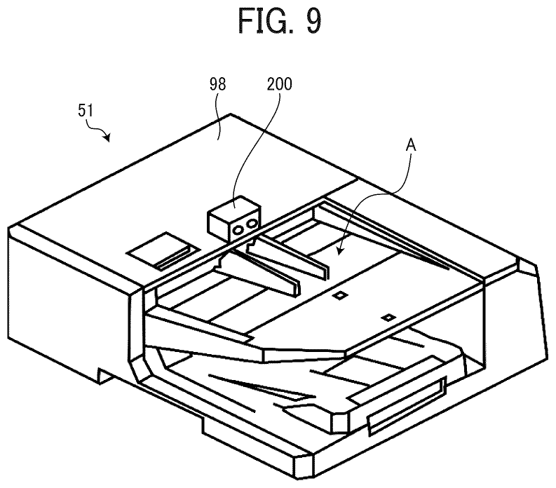

FIG. 9 is a perspective view illustrating an example of the ADF 51 including a floating detection sensor 200.

Since the floating detection sensor 200 needs to be disposed on the downstream side of the document setting part A in the conveyance direction, for example, this is provided above an upper cover 98 of the ADF 51. In order to suppress an influence of a change in detection output due to a position of a staple binding the original documents, the floating detection sensor 200 is arranged in the vicinity of the center of the document setting part A in a main-scanning direction.

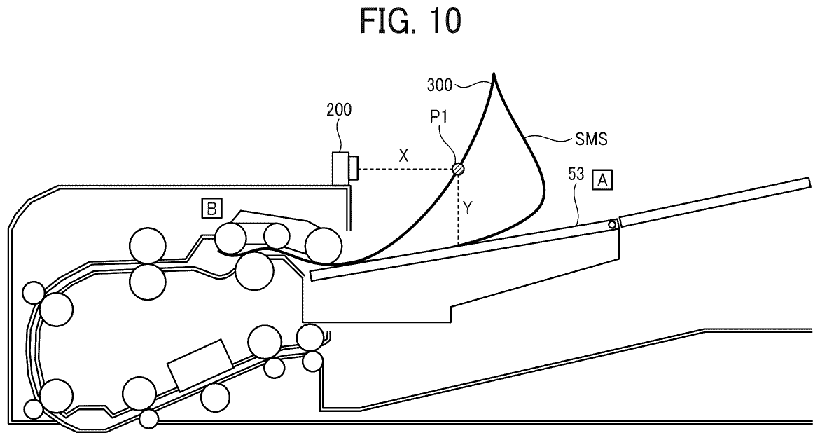

FIG. 10 is a diagram illustrating an example of detection of floating of a bound document SMS.

As illustrated in FIG. 10, when a first page of the bound document SMS is drawn downstream by the separation operation of the separating and feeding part B, the first page is pulled by second and subsequent pages by a binding portion 300 to float. At this time, the floating detection sensor 200 detects the floated bound document SMS at a position P1.

The floating detection sensor 200 is, for example, a ranging sensor that outputs a voltage value corresponding to a distance to an object to be measured. Here, a distance from the floating detection sensor 200 to the position P1 of the bound document SMS is defined as a detection distance X, and a distance from the document loading tray 53 to the position P1 is defined as a detection height Y. The floating detection sensor 200 can change the detection distance X and the detection height Y, for example, by changing a detection threshold value to be described later.

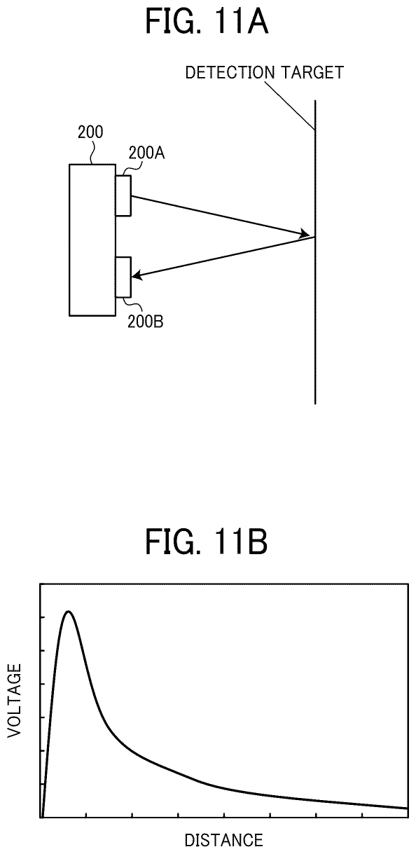

FIGS. 11A and 11B are diagrams for explaining an example of the floating detection sensor 200.

In a case where a ranging sensor is used as the floating detection sensor 200, the floating detection sensor 200 irradiates a detection target with laser light from the light emitting unit 200A as illustrated in FIG. 11A, and receives the laser light reflected by the detection target by a light receiving unit 200B. The floating detection sensor 200 measures the distance from a reflection angle of the laser light received by the light receiving unit 200B, and outputs a voltage value corresponding to the measured distance as illustrated in FIG. 11B. The floating detection sensor 200 detects the object, for example, in a case where the voltage value exceeds a given detection threshold value. The distance at which the voltage value is equal to the detection threshold value is the detection distance X.

The detection height Y of the floating detection sensor 200 can be changed by changing the irradiation angle of the laser light of the ranging sensor.

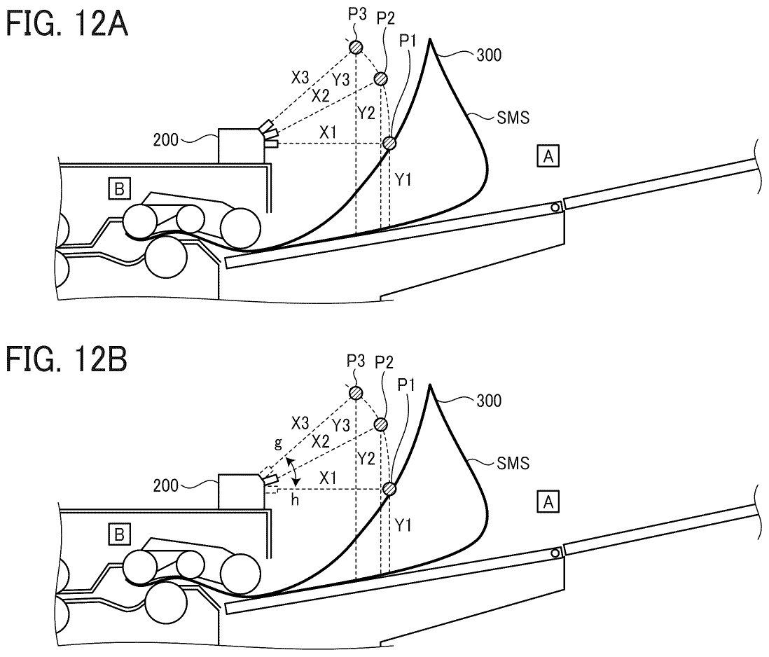

FIGS. 12A and 12B are diagrams illustrating a modified example of the detection height Y.

In the example of FIG. 12A, the floating detection sensor 200 includes multiple light emitting units having different irradiation angles, and can switch the irradiation angle. In the example of FIG. 12B, the floating detection sensor 200 includes a light emitting unit movable in directions indicated by arrows “g” and “h”, and can switch the irradiation angle by rotating the light emitting unit by a motor.

In any of FIGS. 12A and 12B, the floating detection sensor 200 can change the detection position of the bound document SMS to positions P1, P2, and P3 by switching the irradiation angle. As a result, the detection height Y is changed as Y1, Y2, and Y3 in FIGS. 12A and 12B. In the example of FIGS. 12A and 12B, the detection threshold value is constant (detection distance X1, X2, and X3 are equal).

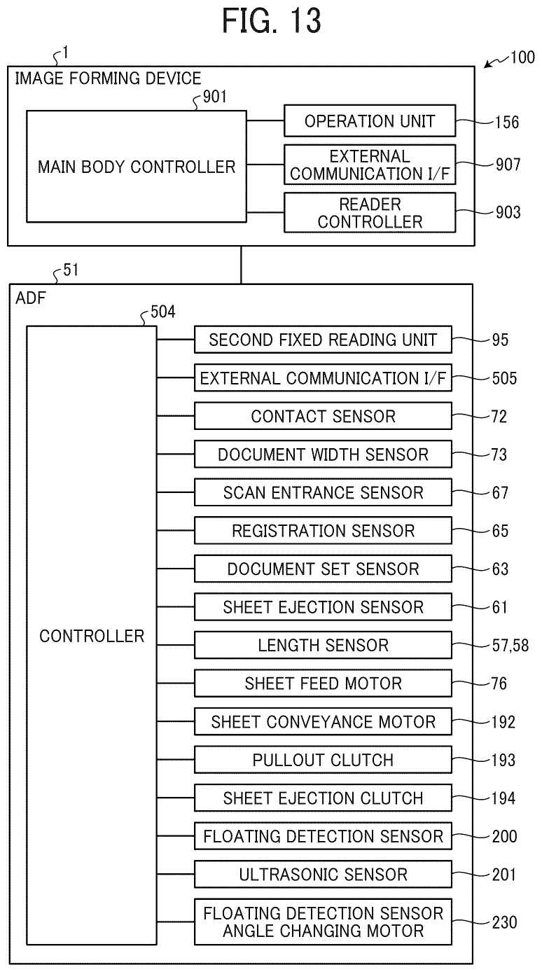

FIG. 13 is a block diagram illustrating a part of an electric circuit of the image forming apparatus 100 according to a first embodiment.

As illustrated in FIG. 13, the image forming device 1 further includes a main body controller 901, an external communication I/F 907, and a reader controller 903 in addition to the above-described configuration. In addition to the above-described configuration, the ADF 51 further includes a controller 504, an external communication I/F 505, a sheet conveyance motor 192, a pullout clutch 193, a sheet ejection clutch 194, and a floating detection sensor angle changing motor 230.

The main body controller 901 and the controller 504 each include a central processing unit (CPU), a random access memory (RAM), a read only memory (ROM), and the like. Each unit of the image forming device 1 is connected to the main body controller 901 and controlled by the main body controller 901. Each unit of the ADF 51 is connected to the controller 504 and controlled by the controller 504. The image forming device 1 and the ADF 51 are communicably connected.

The document set sensor 63, the length sensors 57 and 58, the document width sensor 73, and the ultrasonic sensor 201 connected to the controller 504 are used to acquire information on the document length, the document width, and the paper thickness, respectively. The floating detection sensor angle changing motor 230 is connected to the controller 504 in a case where the irradiation angle of the light emitting unit of the floating detection sensor 200 is changed as illustrated in FIG. 12B.

The external communication I/F 907 and the external communication I/F 505 are interfaces or communicators for performing data communication using a communication network such as the Internet.

The sheet conveyance motor 192 connected to the controller 504 is a rotation drive source for the pullout drive roller 86 in the ADF 51 and the sheet ejection roller pair 94 in FIG. 5. The pullout clutch 193 connected to the controller 504 connects and disconnects the rotation driving force of the sheet conveyance motor 192 to and from the pullout drive roller 86. The sheet ejection clutch 194 connects and disconnects the rotation drive force of the sheet conveyance motor 192 to and from the sheet ejection roller pair 94 as a feeding and conveying device.

Here, an image reading operation of the image forming apparatus 100 will be described. After receiving the registration stop signal from the controller 504, the reader controller 903 sends the reading start signal as a sheet feed permission signal to the controller 504. The controller 504 restarts rotating the sheet conveyance motor 192 and the document reading motor. Then, the timing at which the leading end of the original document MS reaches the reading position of the first fixed reading unit 151 is calculated based on the pulse counts of the document reading motor. At this timing, the controller 504 sends a gate signal indicating an effective image area of the first face of the original document MS in the sub-scanning direction, to the reader controller 903. The controller 504 continues sending the gate signal until the trailing end of the original document MS passes through the reading position of the first fixed reading unit 151, so that the first face of the original document MS is read by the first fixed reading unit 151.

The original document MS that has passed through the first reading and conveying part E passes through the scan exit roller pair 92. Then, the leading end of the original document MS is detected by the sheet ejection sensor 61. In a case where the single-sided reading mode is set, the second face of the original document MS need not be read by the second fixed reading unit 95. When the leading end of the original document MS is detected by the sheet ejection sensor 61, the sheet ejection clutch 194 connects the driving force of the sheet conveyance motor 192 to the sheet ejection roller pair 94. The timing at which the trailing end of the original document MS passes through the nip region of the sheet ejection roller pair 94 is calculated based on the pulse count of the sheet ejection motor after the detection of the leading end of the original document MS by the sheet ejection sensor 61. Based on this calculation result, the sheet ejection clutch 194 is stopped.

In contrast, in a case where the double-sided reading mode is set, the sheet ejection sensor 61 initially detects the leading end of the original document MS. Then, the timing until this reaches the second fixed reading unit 95 is calculated based on the pulse counts of the document reading motor. Then, at this timing, the controller sends a gate signal indicating the effective image area of the second face of the original document MS in the sub-scanning direction to the reader controller. The controller 504 continues sending until the trailing end of the original document MS passes through the reading position of the second fixed reading unit 95, so that the second face of the original document MS is read by the second fixed reading unit 95.

The second fixed reading unit 95 includes contact-type image sensors (CIS) and is coated on the reading face for the purpose of preventing reading vertical streaks due to the paste-like foreign substance adhering to the original document MS to adhere to the reading face of the second fixed reading unit 95. A second reading roller 96 as a document supporter that supports the original document MS from a non-reading face is disposed at a position facing the second fixed reading unit 95. The second reading roller 96 prevents the original document MS from floating at the reading position by the second fixed reading unit 95 and functions as a reference white portion for acquiring shading data on the second fixed reading unit 95.

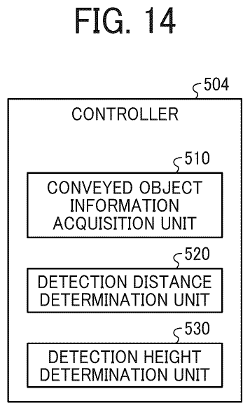

FIG. 14 is a diagram illustrating an example of functional blocks of the controller 504 according to the first embodiment.

As illustrated in FIG. 14, the controller 504 includes a conveyance object information acquisition unit 510, a detection distance determination unit 520, and a detection height determination unit 530. Here, among the functions exhibited by the ADF 51, characteristic functions in the present embodiment will be described.

The conveyance object information acquisition unit 510 acquires length information of the original document as the conveyance object and acquires at least one of width information, thickness information, conveyance speed information, and loading amount information.

The detection distance determination unit 520 determines a detection distance used by the floating detection sensor 200 to detect the floating of the conveyance object. More specifically, the detection distance determination unit 520 determines the detection distance based on the length information of the original document and at least one of the width information, the thickness information, the conveyance speed information, and the loading amount information acquired by the conveyance object information acquisition unit 510.

The detection height determination unit 530 determines a detection height used by the floating detection sensor 200 to detect the floating of the conveyance object. More specifically, the detection height determination unit 530 determines the detection height based on the length information of the original document and at least one of the width information, the thickness information, the conveyance speed information, and the loading amount information acquired by the conveyance object information acquisition unit 510.

The floating detection sensor 200 sets the detection distance and the detection height used for floating detection to the detection distance and the detection height determined by the detection distance determination unit 520 and the detection height determination unit 530 by changing the detection threshold value, or changing the irradiation angle of the laser light. Accordingly, the floating of the conveyance object can be detected according to multiple features (conveyance object information such as height, width, and thickness) of the conveyance object to be conveyed. The floating detection sensor 200 may set only the detection distance used for floating detection. In this case, the controller 504 does not necessarily include the detection height determination unit 530.

The detection distance determination unit 520 and the detection height determination unit 530 determine the detection distance and the detection height, respectively, using a trained model subjected to machine learning based on multiple features (document information) of the original document and information (correct values) of appropriate detection distance and detection height corresponding thereto.

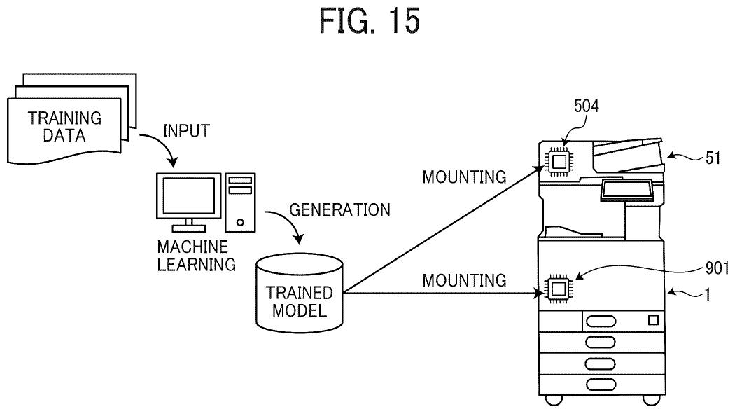

FIG. 15 is a diagram for explaining generation of the trained model according to the first embodiment. The trained model generated in the present embodiment may be referred to as a first model.

The machine learning used for generating the trained model or an artificial intelligence (AI) model is a technique for causing a computer to acquire learning ability like a person, and refers to a technique in which a computer autonomously generates an algorithm necessary for determination such as data identification from learning data captured in advance, and applies the algorithm to new data to perform prediction. A learning method for machine learning may be any one of supervised learning, unsupervised learning, semi-supervised learning, reinforcement learning, and deep learning, and may be a learning method obtained by combining these learning methods, and any learning method for machine learning is applicable.

In the present embodiment, the AI model (first model) generated by machine learning is mounted on a control program written in the CPU of the controller 504. The AI model is generated, for example, by machine learning of teacher data created from data obtained by evaluation at the time of designing the ADF 51 using an external personal computer (PC) or a cloud service. The generated AI model is a kind of calculation algorithm, is modularized as a part of the control program, and is mounted on the CPU of the controller 504 as illustrated in FIG. 15.

The main body controller 901 may include the detection distance determination unit 520 and the detection height determination unit 530 described above. In this case, the AI model is mounted on the CPU of the main body controller 901.

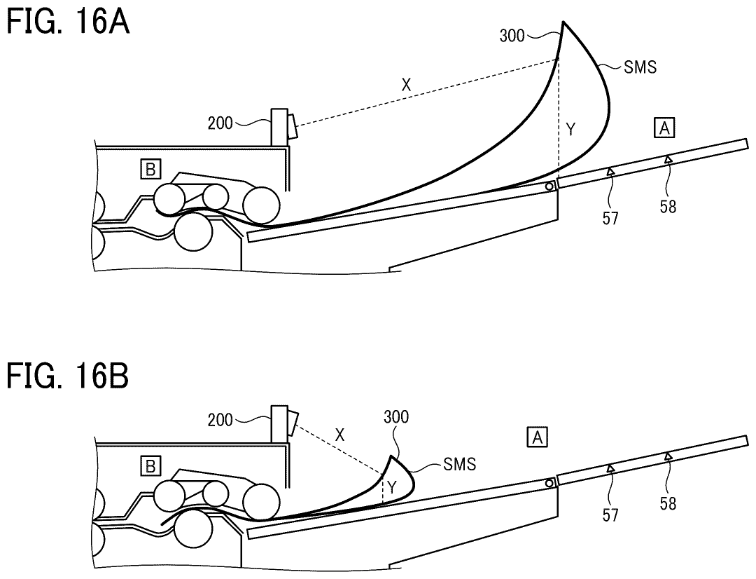

An example of the teacher data (data obtained by combining the document information and correct value) used for machine learning according to the present embodiment will be described with reference to FIGS. 16A to 21.

FIGS. 16A and 16B are diagrams illustrating an example of the detection distance and the detection height used for floating detection.

Here, the detection distance and the detection height are the correct values of the detection distance and the detection height, and are appropriate detection distance and detection height with which the original document is less likely to be folded or torn and with which the bound document can be detected with less erroneous detection. The correct value of the detection distance is an example of a given detection distance, and the correct value of the detection height is an example of a given detection height.

As illustrated in FIG. 16A, in a case where the document length is long (for example, exceeding a detection range of the length sensor 58), it is necessary to increase the detection distance X to detect early in order to prevent the bound document SMS from being folded or torn. As illustrated in FIG. 16B, in a case of the bound document SMS having a short document length, since a floating height is low, it is necessary to reduce the detection height Y and to increase the detection distance X. In this manner, since a floating manner (floating characteristic) of the original document differs according to a difference in document information, an appropriate value is set as the correct value of the teacher data according to the difference in document information.

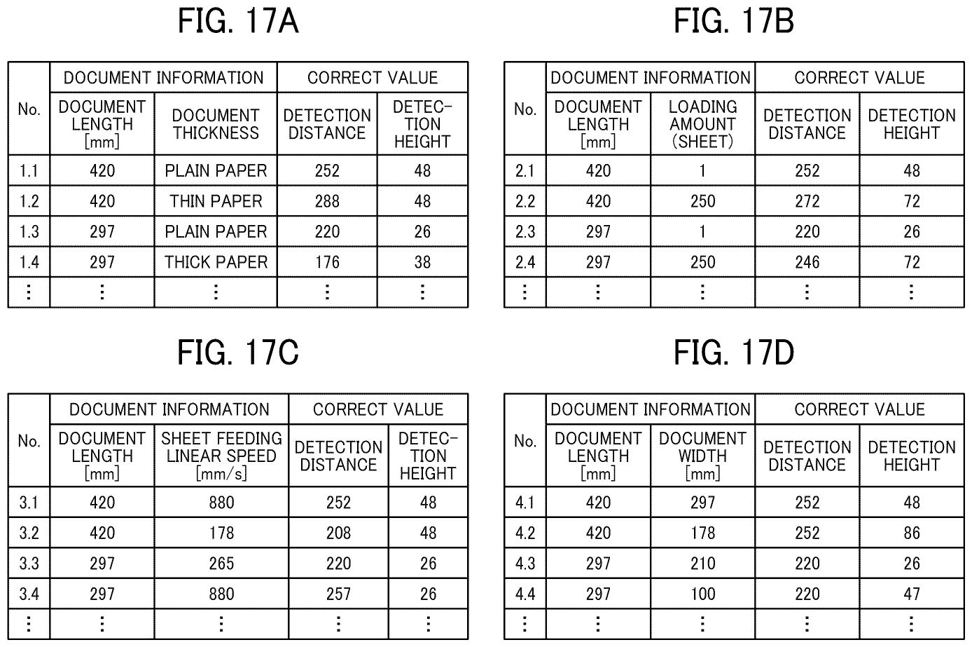

FIGS. 17A, 17B, 17C and 17D are diagrams illustrating an example of the teacher data. In this example, the document length and another type of document information are used as the document information.

The other type of document information is a document thickness in FIG. 17A, a loading amount in FIG. 17B, a sheet feeding linear speed (conveyance speed) in FIG. 17C, and a document width in FIG. 17D.

In a case of using the teacher data of FIG. 17A, it is possible to learn the correct value reflecting a degree of folding or tearing due to the paper thickness by adding paper thickness information to the document length. For example, in a case of thin paper, since folding or tearing is likely to occur as compared with the plain paper thickness, it is necessary to stop the conveyance operation early, and the detection distance of the correct value is increased. In contrast, in a case of thick paper, since folding or tearing is less likely to occur, the detection distance and the detection height can be reduced, and the detection accuracy can be enhanced.

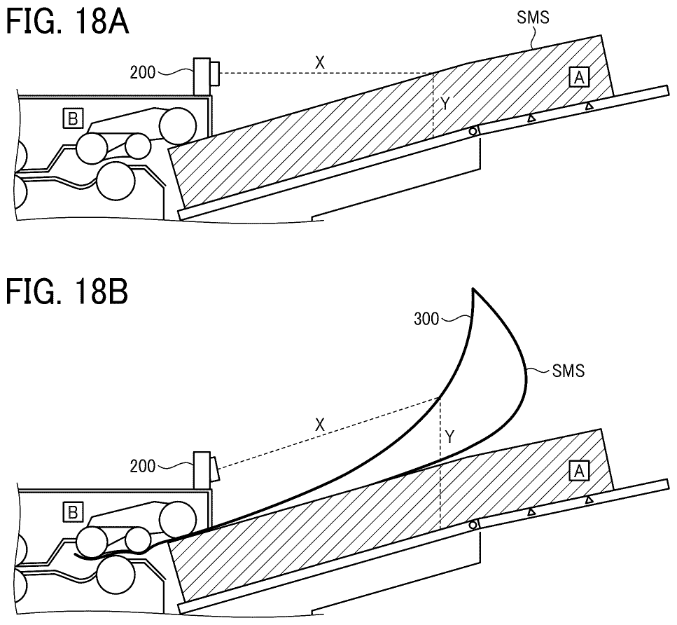

FIGS. 18A and 18B are other diagrams illustrating an example of the detection distance and detection height used for floating detection.

When the detection distance X and the detection height Y as illustrated in FIG. 18A are used for the document SMS loaded as illustrated in FIGS. 18A and 18B, for example, there is a case where an uppermost surface of the document SMS is detected as floating. In contrast, for example, by including a combination of the loading amount, the detection distance X, and the detection height Y as illustrated in FIG. 18B in the teacher data, it is possible to prevent erroneous detection of the uppermost surface of the loaded document SMS. Even with the same loading amount, the longer the document length, the higher the position of the loaded document surface, so that there is a case where it is necessary to increase the detection height of the correct value. FIG. 17B is an example of the teacher data corresponding to such case.

In a case of using the teacher data of FIG. 17C, it is possible to learn an optimum correct value according to the speed by adding sheet feeding linear speed information to the document length. For example, in a case where the sheet feeding linear speed is high, the original document is likely to be folded or torn, so that it is necessary to detect early. Therefore, the detection distance of the correct value is increased. The detection height of the correct value may be reduced in order to detect early in a case where the sheet feeding linear speed is large.

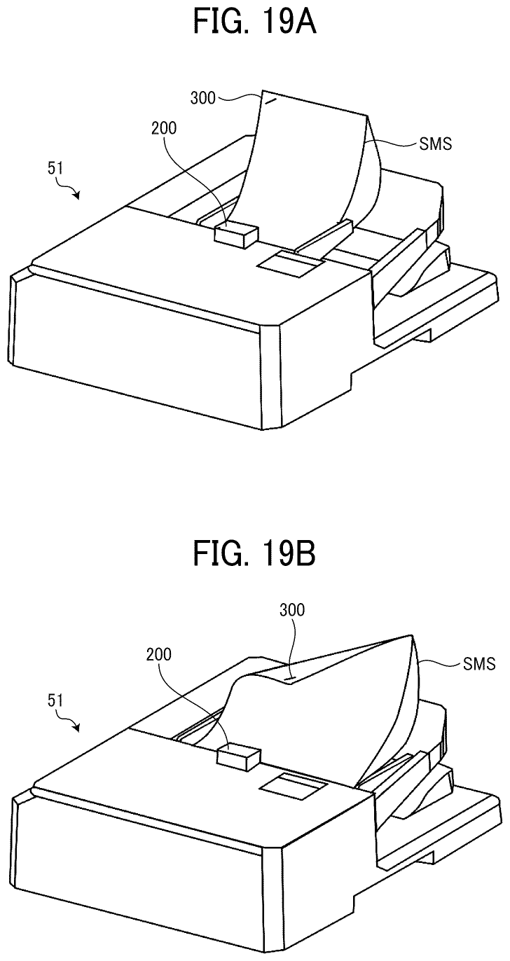

FIGS. 19A and 19B are diagrams illustrating a difference in floating characteristic depending on the document width.

In a case where the document width is small as illustrated in FIG. 19A, since the position of the binding portion 300 is close to the pickup roller 80 and the separation roller 85 in the width direction, folding and tearing are small, and the floating height is large. In contrast, in a case where the document width is large as illustrated in FIG. 19B, the floating height becomes small, and folding or tearing is likely to occur. Therefore, in a case where the document width is large, it is necessary to increase the detection distance and reduce the detection height. FIG. 17D is an example of teacher data corresponding to such a case. By adding the document width information to the document length, it is possible to perform machine learning using teacher data in consideration of a difference in floating characteristic depending on the document width.

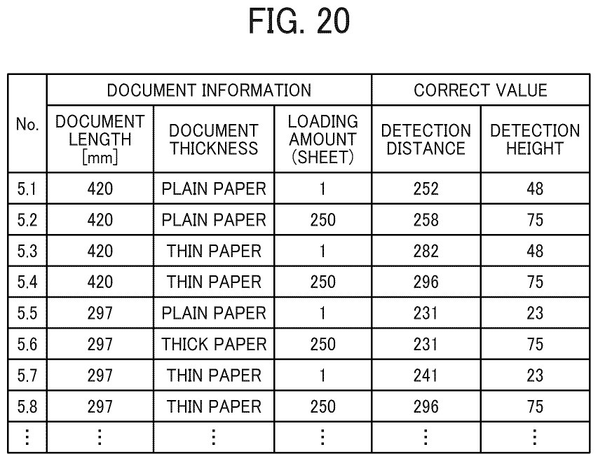

FIG. 20 is a diagram illustrating another example of the teacher data.

A difference from FIGS. 17A to 17D is that the document length and other two types of document information are used as the document information. In this example, information on the paper thickness and the loading amount is used as the other two types of document information. For example, when the detection height of the correct value is increased in a case where the loading amount is large, a time until the detection is extended, and folding and tearing are likely to occur. Therefore, the teacher data is set by slightly increasing the detection distance of the correct value so that the correct value can be detected early. At this time, the detection distance of the correct value is made longer for thin paper than for plain paper. Since thick paper is less likely to be folded or torn, it is not necessary to increase the detection distance of the correct value in a case where the loading amount is large.

By further combining three or more pieces of other document information with the document length information, it is possible to set teacher data corresponding to various floating characteristics.

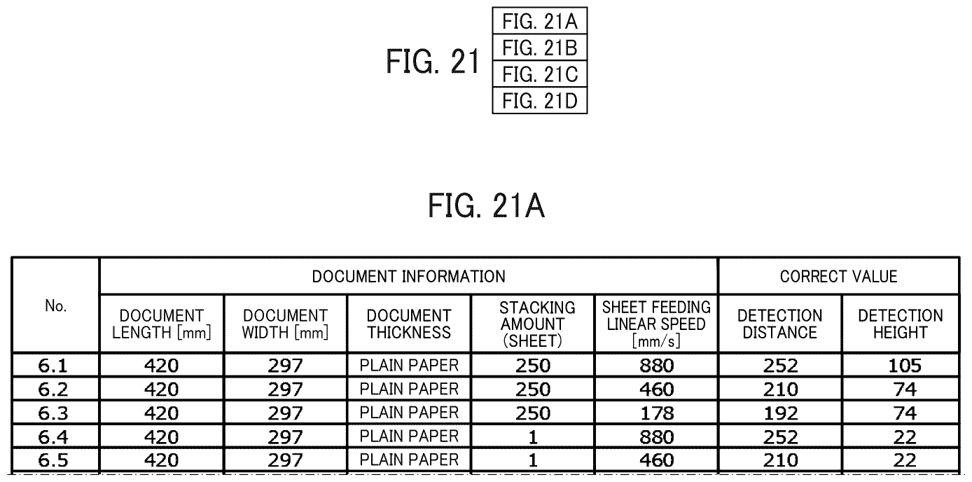

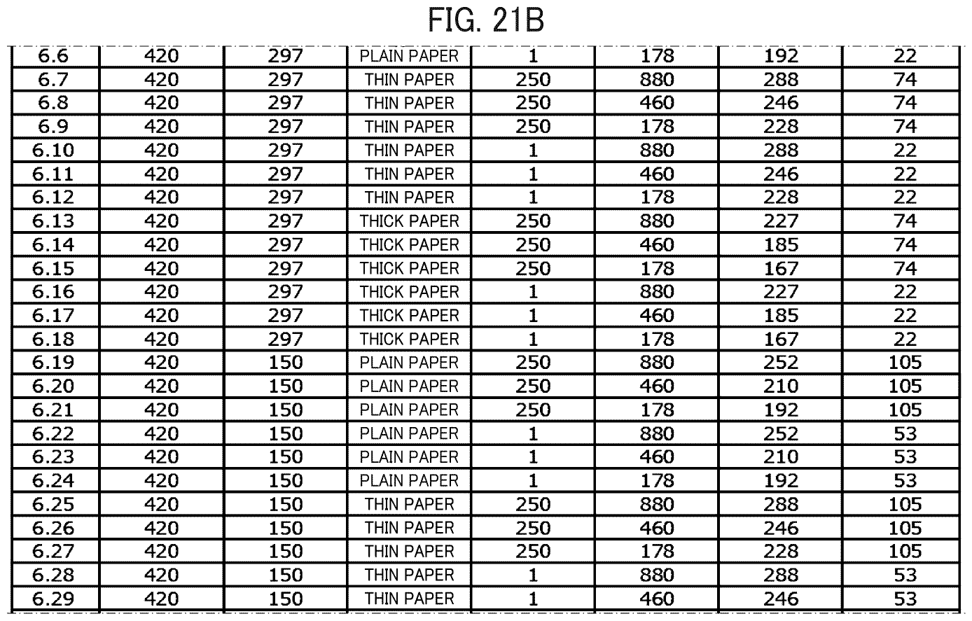

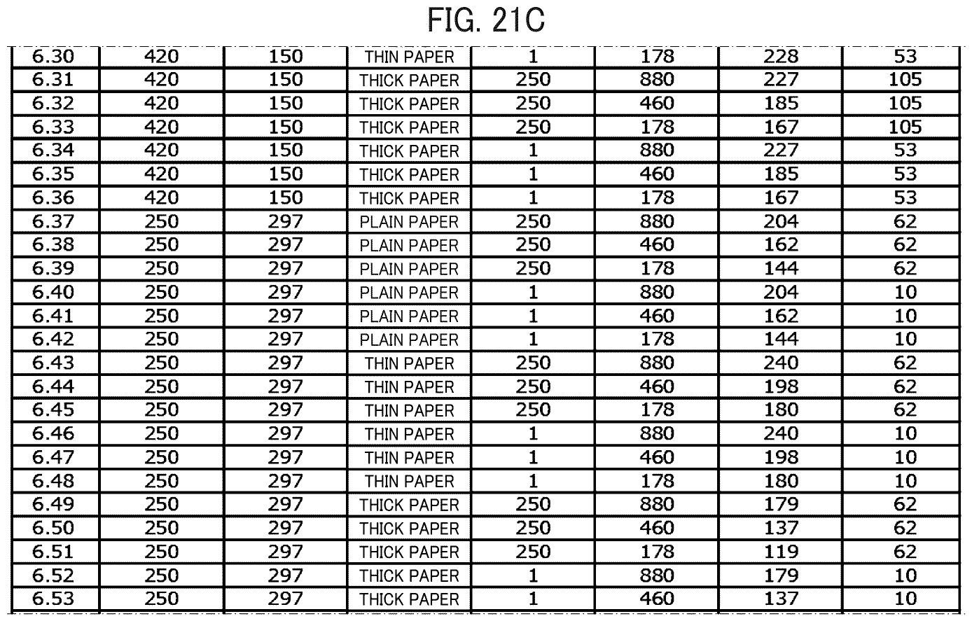

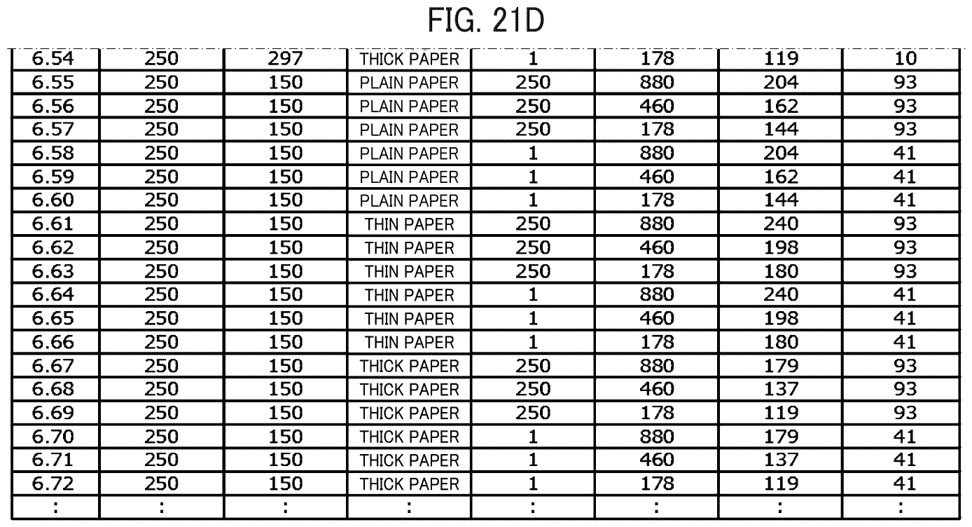

FIG. 21 including FIGS. 21A, 21B, 21C and 21D is a diagram illustrating another example of the teacher data.

A difference from FIGS. 17A to 17D is that four pieces of information (document width, paper thickness, loading amount, and sheet feeding linear speed) are used as other document information. In this example, teacher data including 72 patterns of correct values is set for a combination of the document length (maximum/minimum), the document width (maximum/minimum), the paper thickness (plain/thick/thin), the loading amount (maximum/minimum), and the sheet feeding linear speed (high speed/medium speed/low speed).

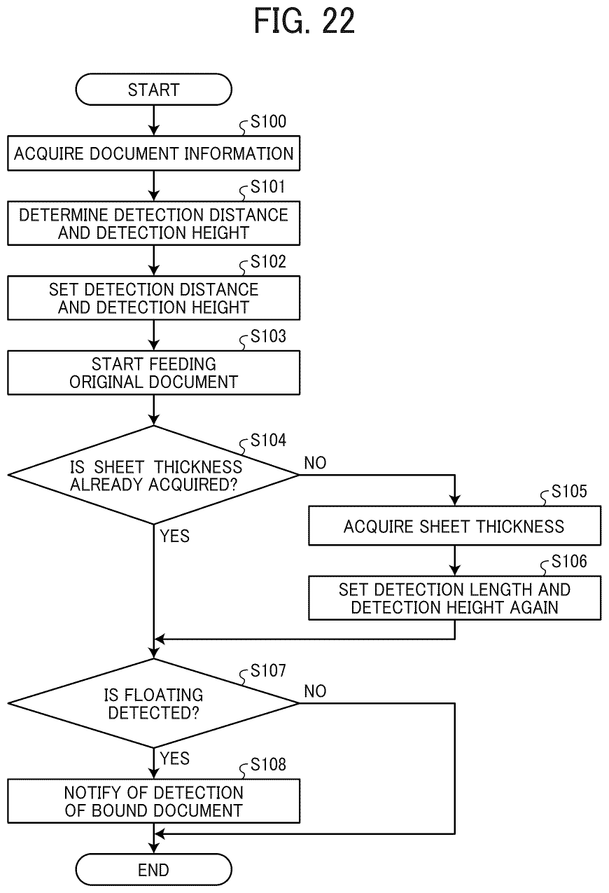

FIG. 22 is a flowchart illustrating an example of detection processing according to the first embodiment.

First, the conveyance object information acquisition unit 510 acquires the document information such as the document length, the loading amount, and the document width (step S100). The detection distance determination unit 520 and the detection height determination unit 530 determine the detection distance and the detection height, respectively, based on the document information (step S101).

The floating detection sensor 200 sets the detection distance and the detection height used for floating detection to the determined detection distance and detection height (step S102).

The ADF 51 starts feeding the original document (step S103), and in a case where the paper thickness has been acquired (for example, the operator has already input from the operation unit 156) (step S104: Yes), the procedure proceeds to step S107. In contrast, in a case where the paper thickness has not been acquired (step S104: No), the conveyance object information acquisition unit 510 acquires the paper thickness based on the information acquired by the ultrasonic sensor 201 (step S105). In this case, the floating detection sensor 200 resets the detection distance and the detection height based on the document information including the acquired paper thickness information (step S106).

In a case where the floating detection sensor 200 detects the floating of the original document (step S107: Yes), the ADF 51 notifies the operator that the bound document is detected (step S108). In contrast, in a case where the floating detection sensor 200 does not detect the floating of the original document (step S107: No), the procedure ends. The operator is notified, for example, by displaying an error on the touch panel 157 of the operation unit 156, blinking an error indicator of the image forming apparatus 100. In a case where the operator is notified that the bound document is detected, the conveyance operation is stopped.

The detection distance determination unit 520 and the detection height determination unit 530 may determine the detection distance and the detection height without using the AI model. For example, in a case where an original document having document information corresponding to No. 6.1 in FIG. 21 is set, the detection distance determination unit 520 and the detection height determination unit 530 can output the detection distance X=252 and the detection height Y=105, which are correct values, with reference to the information in FIG. 21 stored in a storage unit such as the ROM of the ADF 51.

As described above, according to the present embodiment, it is possible to detect the floating of the conveyance object according to multiple features of the conveyance object to be conveyed.

### Second Embodiment

In a second embodiment, it is determined whether a detection target detected by a floating detection sensor 200 is a conveyance object such as an original document. For example, in a case where a hand of an operator enters a range irradiated with laser light of the floating detection sensor 200 or in a case where another shielding object shields the laser light, an error may occur in a detection result of the floating detection sensor 200. In the present embodiment, the above disadvantage is avoided by determining whether the detection target is the conveyance object such as the original document based on time-series output information (voltage value) output by the floating detection sensor 200. In the following description of the second embodiment, descriptions of elements overlapped with those in the first embodiment are omitted, and differences from the first embodiment are described.

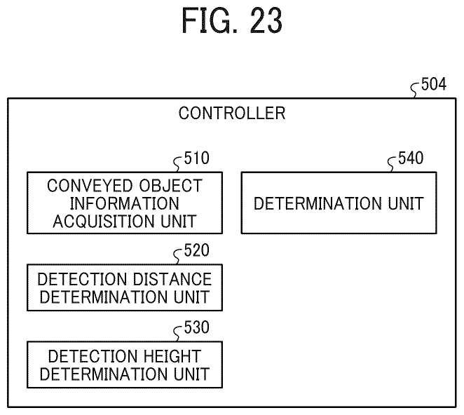

FIG. 23 is a diagram illustrating an example of functional blocks of a controller 504 according to the second embodiment.

The difference from FIG. 14 is that the controller 504 further includes a determination unit 540. Here, among the functions exhibited by the ADF 51, characteristic functions in the present embodiment will be described.

The determination unit 540 determines whether the detection target detected by the floating detection sensor 200 is the conveyance object such as the original document based on the time-series output information output by the floating detection sensor 200.

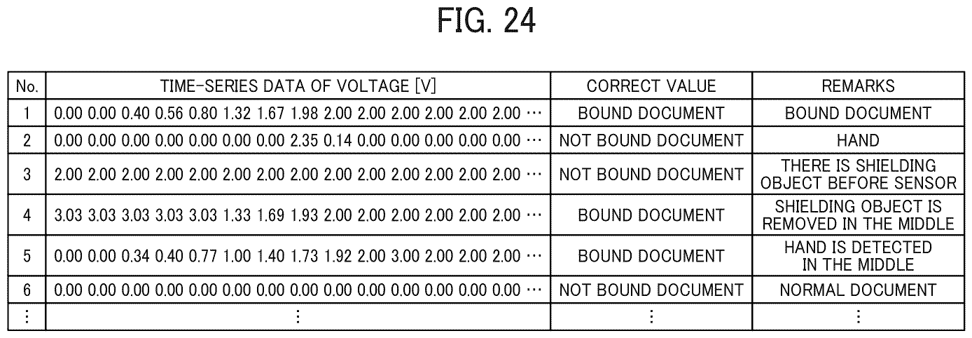

FIG. 24 is a diagram illustrating an example of time-series data of a voltage output from the floating detection sensor 200.

In this example, each row of a table illustrates the time-series data of the voltage, a correct value used for learning of an AI model (second model) to be described later, and remark information in association with each other.

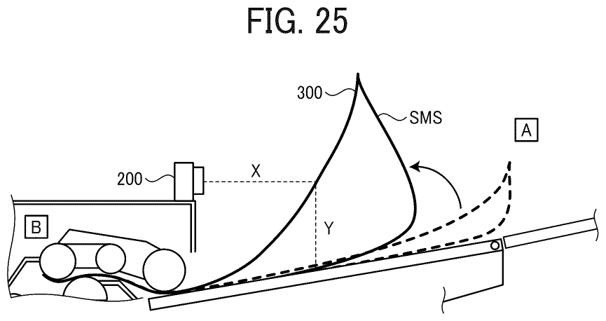

FIG. 25 is an example illustrating a state in which floating of a bound document SMS is detected.

In this example, the bound document SMS is not detected when this is at a position indicated by broken line, but is detected when this floats to a position indicated by solid line of a position of a detection distance X and a detection height Y. In this case, as the bound document SMS approaches the detection distance, the time-series data of the voltage of the floating detection sensor 200 is as No. 1 in FIG. 24.

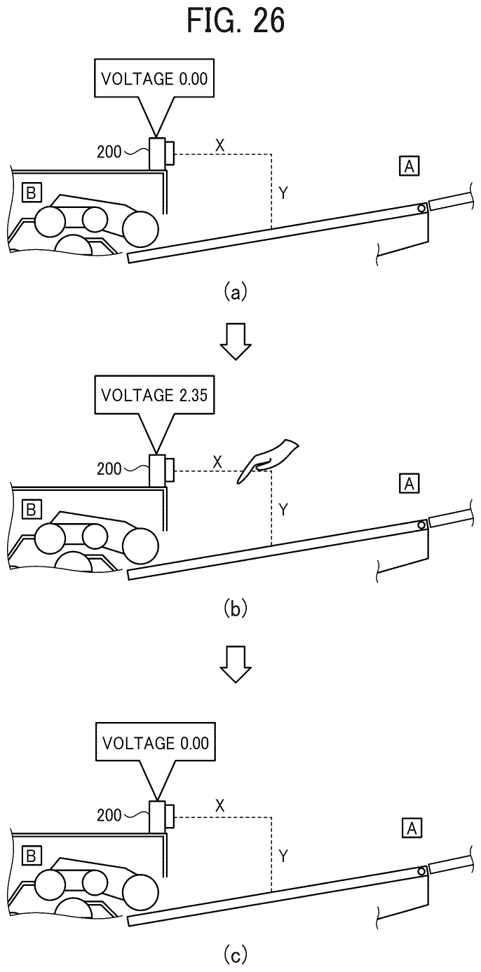

FIG. 26 including parts (a), (b) and (c) is an example illustrating a state in which a hand crosses an irradiation range of the floating detection sensor 200.

As illustrated in the parts (a), (b) and (c) of FIG. 26, the voltage of the floating detection sensor 200 is 0 before and after the hand crosses, but the voltage of the floating detection sensor 200 becomes a high value while the hand crosses as illustrated in the part (b) of FIG. 26. In this manner, in a case where an operator's hand or a person passes, the time-series data of the voltage is time-series data different from that of No. 1 in FIG. 24, for example, the voltage becomes 0 or larger only at the moment of passage as in No. 2 in FIG. 24. The determination unit 540 discriminates whether the detection target is the original document by using the second model subjected to machine learning of a difference in time-series data.

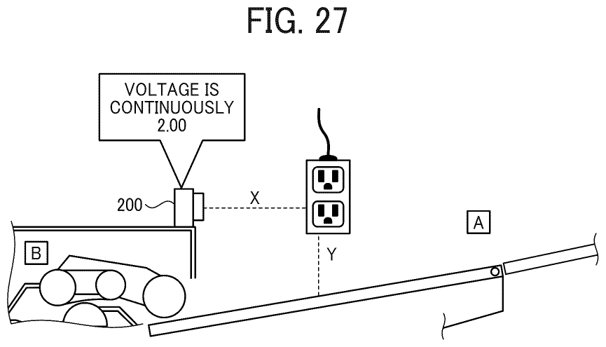

FIG. 27 is an example illustrating a state in which a shielding object is placed in an irradiation range of the floating detection sensor 200.

In this case, the time-series data of the voltage has a value larger than 0 that is temporally constant as No. 3 in FIG. 24.

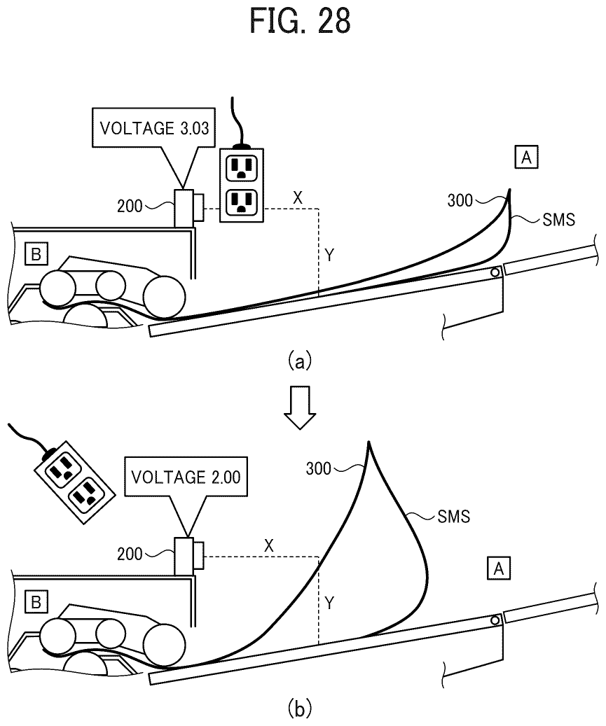

FIG. 28 including parts (a) and (b) is an example illustrating a state in which the shielding object is removed after feeding of the original document is started.

When the shielding object is placed as illustrated in the part (a) of FIG. 28, the voltage of the floating detection sensor 200 indicates a high value. As illustrated in the part (b) of FIG. 28, when the original document floats when the shielding object is removed, the voltage of the floating detection sensor 200 indicates a value of 0 or larger. In this case, the time-series data of the voltage changes as No. 4 in FIG. 24.

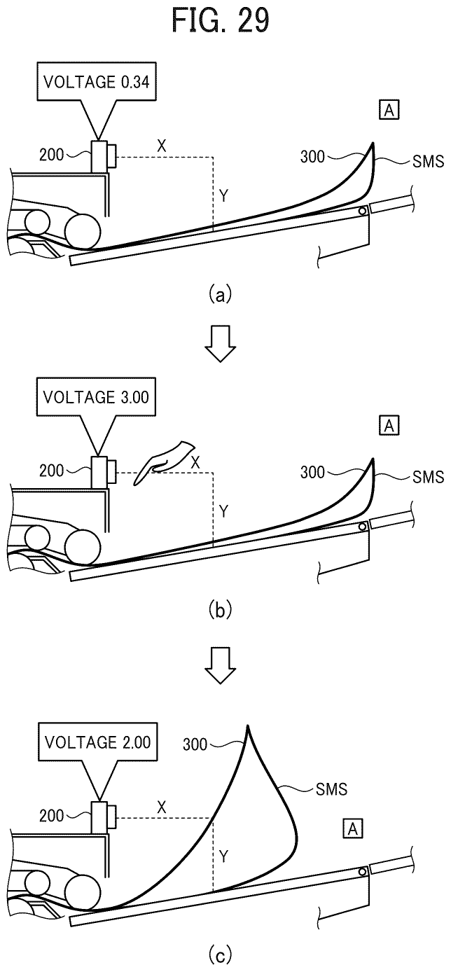

FIG. 29 including parts (a), (b) and (c) is an example illustrating a state in which a hand crosses the irradiation range of the floating detection sensor 200 after the feeding of the original document is started.

As illustrated in the parts (a), (b) and (c) of FIG. 29, the voltage of the floating detection sensor 200 becomes a value close to No. 1 in FIG. 24 before and after the hand crosses, but the voltage of the floating detection sensor 200 becomes a high value while the hand crosses as illustrated in the part (b) of FIG. 29. In this case, in the time-series data of the voltage, the voltage becomes a high value only at the moment of passage as in No. 5 in FIG. 24, and otherwise, this becomes the time-series data close to No. 1 in FIG. 24.

In FIG. 24, No. 6 is the time-series data of the voltage in a case where the original document that is not a bound document is fed. In this case, since the voltage of the floating detection sensor 200 is always 0, the determination unit 540 can discriminate that the original document is not the bound document based on the time-series data of the voltage.

In the present embodiment, it is possible to enhance the detection accuracy of the bound document by performing machine learning of the AI model (second model) for discriminating whether the detection target is the bound document or other objects using the data illustrated in FIG. 24 as the teacher data.

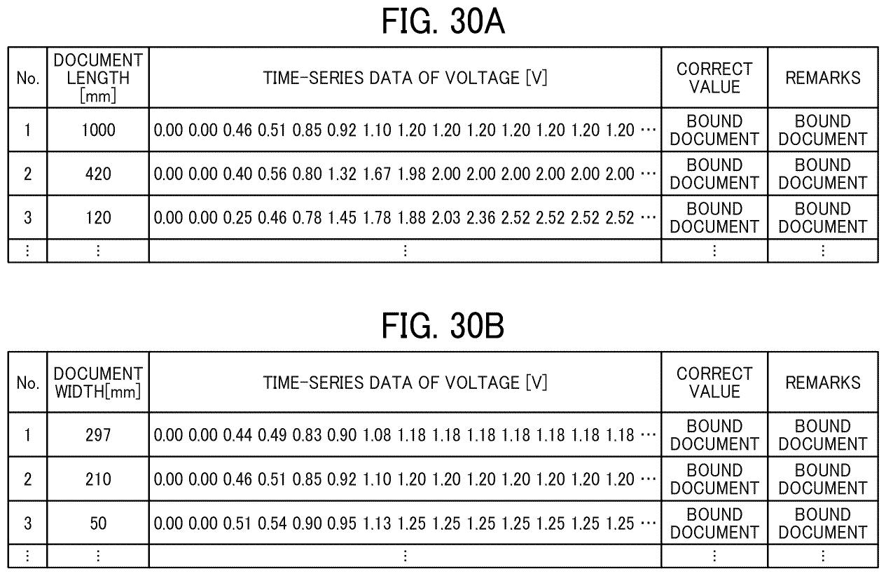

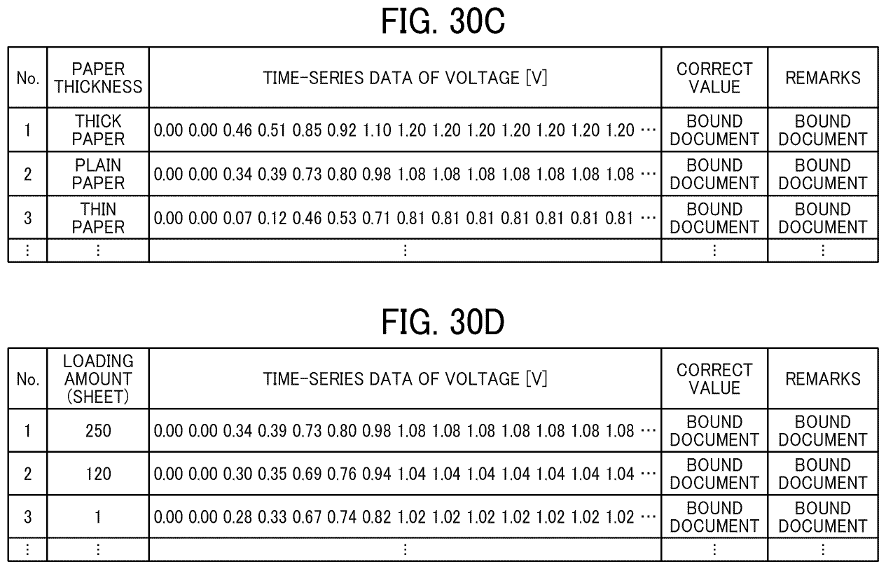

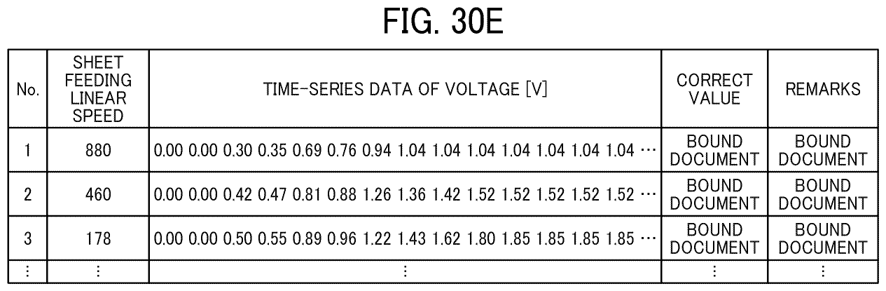

FIGS. 30A to 30E are diagrams illustrating an example of the teacher data using a combination of the document information and the time-series data of the voltage.

FIG. 30A illustrates an example in which a correct value corresponding to a combination of a document length and the time-series data of the voltage is used as the teacher data.

FIG. 30B illustrates an example in which a correct value corresponding to a combination of a document width and the time-series data of the voltage is used as the teacher data.

FIG. 30C illustrates an example in which a correct value corresponding to a combination of a paper thickness and the time-series data of the voltage is used as the teacher data.

FIG. 30D illustrates an example in which a correct value corresponding to a combination of a loading amount and the time-series data of the voltage is used as the teacher data.

FIG. 30E illustrates an example in which a correct value corresponding to a combination of a sheet feeding linear speed and the time-series data of the voltage is used as the teacher data.

FIGS. 30A to 30E illustrate data in which the time-series data of No. 1 in FIG. 24 has changed according to a change in each document information (document length and document width). In this manner, the second model is subjected to machine learning using the correct value corresponding to the combination of the document information and the time-series data of the voltage as the teacher data, and the determination unit 540 performs determination based on the document information, the time-series data of the voltage, and the second model, so that the detection accuracy of the bound document can be further enhanced.

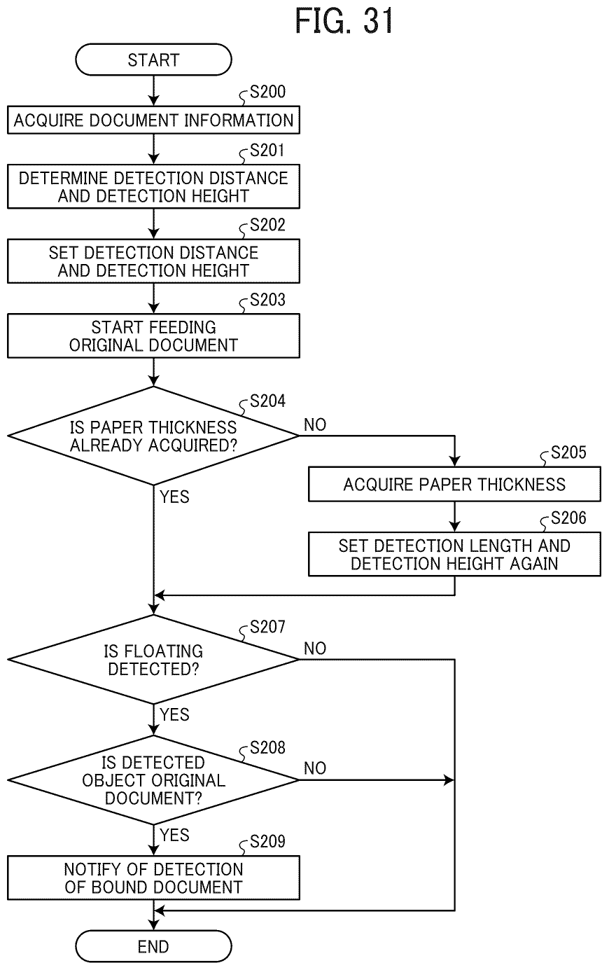

FIG. 31 is a flowchart illustrating an example of detection processing according to the second embodiment.

A difference from FIG. 22 is that determination processing by the determination unit 540 is added as step S08. Since the processing at steps S200 to S207 and S209 of FIG. 31 is similar to the processing at steps S100 to S108 of FIG. 22, the description thereof will be omitted.

In a case where floating is detected at step S207, the determination unit 540 determines whether the detected detection target is the original document (step S208). In a case where it is determined that the detection target is the original document (step S208: Yes), the procedure proceeds to step S209. In contrast, in a case where it is determined that the detection target is not the original a document (step S208: No), the procedure ends.

As described above, according to the present embodiment, it is possible to detect the floating of the conveyance object according to multiple features of the conveyance object to be conveyed. By determining whether the detection target detected by the floating detection sensor 200 is the conveyance object such as the original document, the detection accuracy of the bound document can be enhanced.

### Third Embodiment

In a third embodiment, an external system has functions of a detection distance determination unit 520, a detection height determination unit 530, and a determination unit 540. In the following description of the third embodiment, descriptions of elements overlapped with those in the first and second embodiments are omitted, and differences from the first and second embodiments are described.

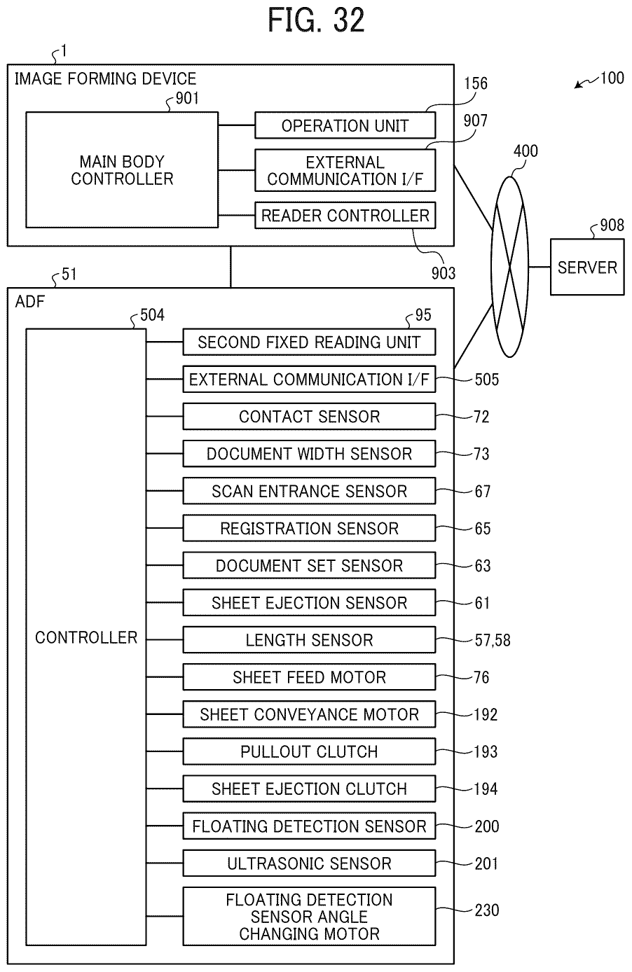

FIG. 32 is a block diagram illustrating a part of an electric circuit of an image forming apparatus 100 according to the second embodiment.

A difference from FIG. 13 is that the image forming apparatus 100 is connected to a server 908, which is an example of an external system, via a network 400.

The server 908 has functions of the detection distance determination unit 520 and the detection height determination unit 530, and determines appropriate detection distance and detection height based on document information and an output of a floating detection sensor 200. The server 908 may further have the function of the determination unit 540 as a determiner. In this case, the server 908 determines whether a detection target is a conveyance object such as an original document based on time-series data of a voltage of the floating detection sensor 200.

The image forming apparatus 100 sends information acquired by a conveyance object information acquisition unit 510 to the server 908, and receives at least one of the detection distance and the detection height used for detection by the floating detection sensor 200 from the server 908. The connection between the image forming apparatus 100 and the server 908 may be any of connection between the external communication I/F 505 and the server 908, connection between an external communication I/F 907 and the server 908, and connection between both the external communication I/F 505 and the external communication I/F 907 and the server 908.

In a case where the server 908 further has the function of the determination unit 540, the image forming apparatus 100 sends the time-series data of the voltage of the floating detection sensor 200 to the server 908, and receives a determination result of the determination unit 540 from the server 908.

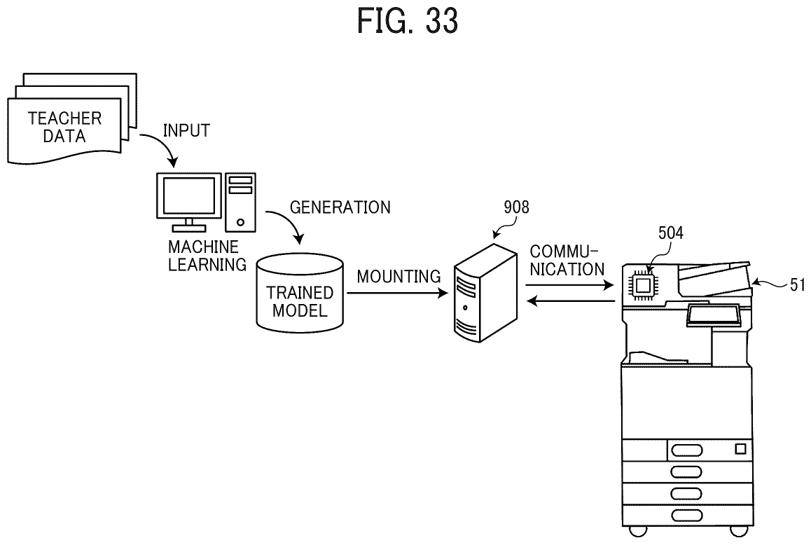

FIG. 33 is a diagram for explaining generation of a trained model according to the first embodiment.

A difference from FIG. 15 is that the trained model (a first model or a second model) is mounted on the server 908, and the server 908 determines a detection distance and a detection height using the trained model and determines whether the detection target is a conveyance object such as the original document.

As described above, according to the present embodiment, it is possible to detect the floating of the conveyance object according to multiple features of the conveyance object to be conveyed. The external system can have the functions of the detection distance determination unit 520, the detection height determination unit 530, and the determination unit 540.

### Fourth Embodiment

In a fourth embodiment, floating detection processing is not performed on a small-size original document such as a receipt (receipt document) issued when purchasing a product or a merchandise. In the following description of the fourth embodiment, descriptions of elements overlapped with those in the first to third embodiments are omitted, and differences from the first to third embodiments are described.

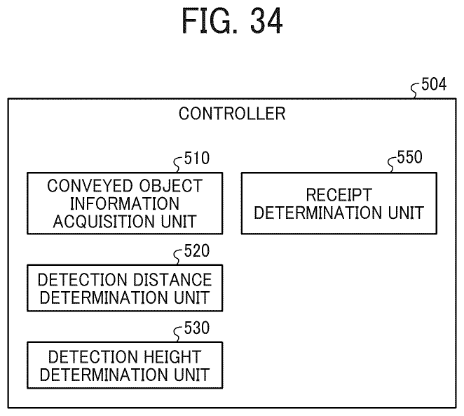

FIG. 34 is a diagram illustrating an example of functional blocks of a controller 504 according to the second embodiment.

The difference from FIG. 14 is that the controller 504 further includes a receipt determination unit 550. Here, among the functions exhibited by the ADF 51, characteristic functions in the present embodiment will be described.

The receipt determination unit 550 determines whether the original document is the receipt document based on document information acquired by a conveyance object information acquisition unit 510. For example, in a case where a document width is the minimum (or a given value α or less) and a document length is a given value β or more, the receipt determination unit 550 determines that this is the receipt document. Here, the values α and β are values determined in advance by experiments.

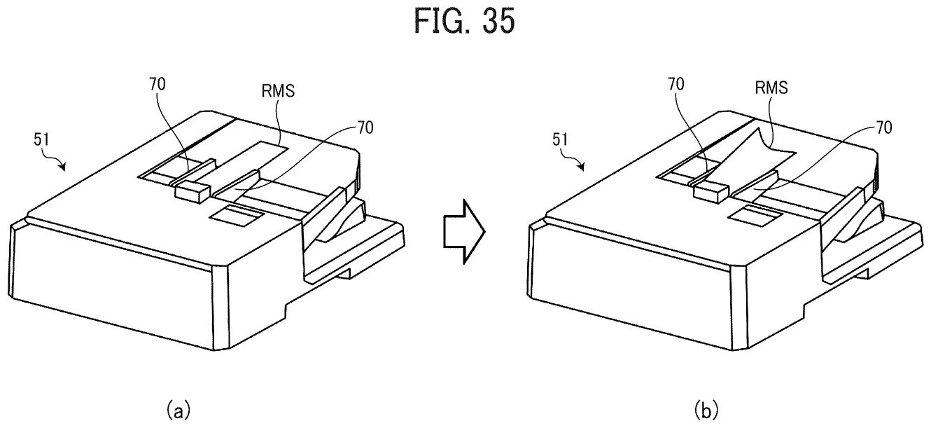

FIGS. 35A and 35B are diagrams illustrating a state in which a receipt document RMS is fed to the ADF 51.

FIG. 35A illustrates a state in which the receipt document RMS is loaded, and FIG. 35B illustrates a state after feeding of the receipt document RMS is started.

As illustrated in FIGS. 35A and 35B, even in a case where the receipt document RMS is not a bound document, there is a case where the receipt document RMS runs on a side fence 70 and is lifted at the time of sheet feeding. However, the receipt document has a low probability of being a bound document, and in order to prevent the lifted receipt from being detected as the bound document, in the present embodiment, in a case of determining that the document is the receipt document, the floating detection processing is not performed.

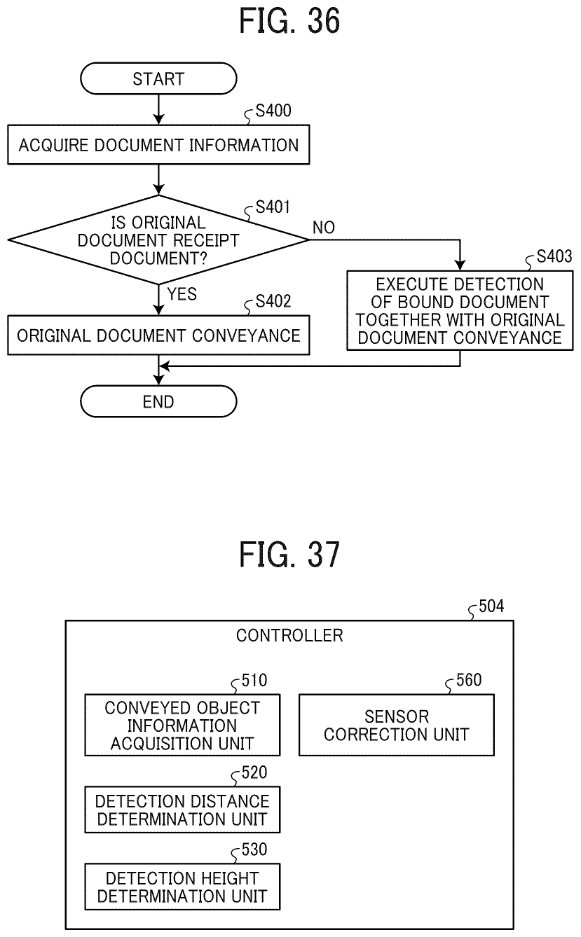

FIG. 36 is a flowchart illustrating an example of document conveyance processing according to the fourth embodiment.

First, the conveyance object information acquisition unit 510 acquires the document information (step S400).

Subsequently, the receipt determination unit determines whether the original document is the receipt document (step S401), and in a case where it is determined that the original document is the receipt document (step S401: Yes), the original document is conveyed without performing the floating detection processing (step S402). In contrast, in a case where it is determined that the original document is not the receipt document (step S401: No), the bound document detection processing according to any one of the first to third embodiments is executed together with document conveyance (step S403).

The controller 504 may have a function of determining whether the original document is a business card instead of the receipt determination unit 550 or together with the receipt determination unit 550. For example, in a case where the original document has a small size and is thick paper, it can be determined that the original document is the business card. Since the business card is unlikely to be the bound document, the floating detection processing is not necessarily performed similarly to the receipt document.

As described above, according to the present embodiment, it is possible to prevent erroneous detection in the detection processing of the bound document by not performing the floating detection processing for the small-size documents.

### Fifth Embodiment

In a fifth embodiment, a floating detection sensor 200 is calibrated (corrected). In the following description of the fifth embodiment, descriptions of elements overlapped with those in the first to fourth embodiments are omitted, and differences from the first to fourth embodiments are described.

FIG. 37 is a diagram illustrating an example of functional blocks according to the fifth embodiment.

The difference from FIG. 14 is that the controller 504 further includes a sensor correction unit 560. Here, among the functions exhibited by the ADF 51, characteristic functions in the present embodiment will be described.

The sensor correction unit 560 performs correction processing of the floating detection sensor 200. Since the floating detection sensor 200 is required to accurately detect the bound document, it is necessary to maintain the accuracy by correction processing at any time. For example, the sensor correction unit 560 performs processing of correcting a voltage (reference value) output from the floating detection sensor 200 to be 0 when the ADF 51 is not in use.

The sensor correction unit 560 corrects the floating detection sensor 200 with reference to a voltage value stored in a storage unit such as a ROM. For example, in a case where a voltage value (normal value) when a given number of original documents are set is stored, the floating detection sensor 200 is corrected such that an output voltage when the given number of original documents are set is equal to the normal value. That is, the sensor correction unit 560 corrects sensitivity of the floating detection sensor 200 with respect to the given number of original documents. The given number is any number such as 10, 100, and 250, and a normal value when each given number of original documents are set is stored.

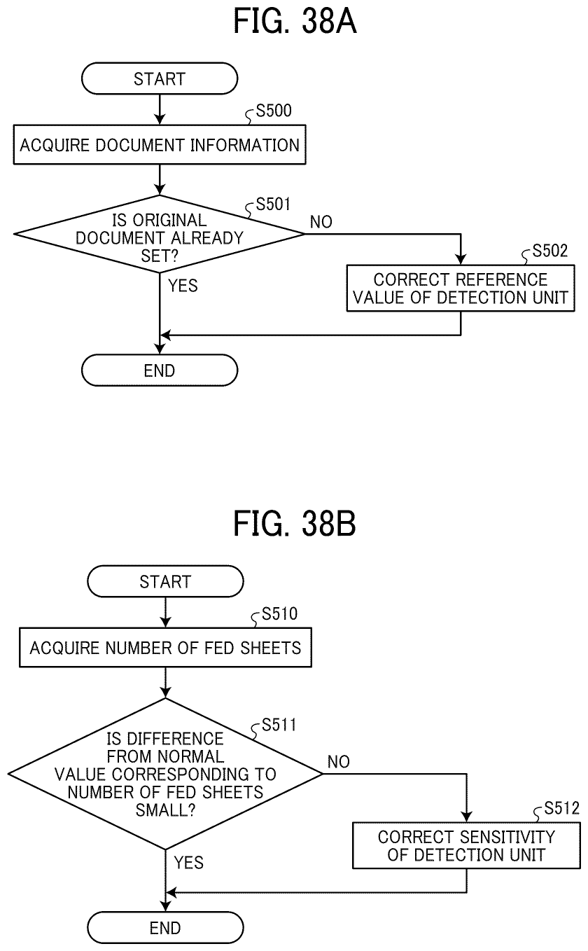

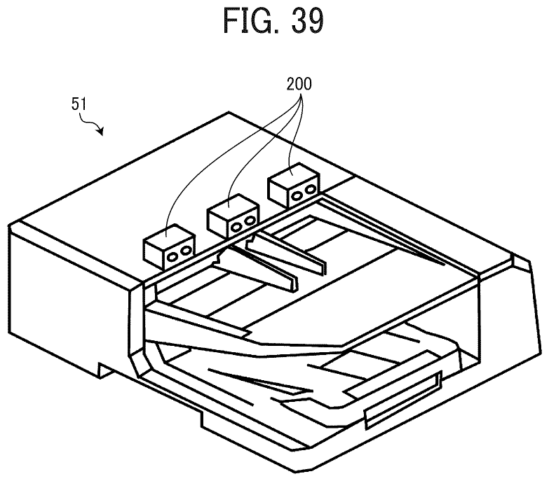

FIGS. 38A and 38B are flowcharts illustrating an example of correcting processing according to the fifth embodiment.

FIG. 38A is an example of a case where the output voltage of the floating detection sensor 200 is corrected to be 0. First, the conveyance object information acquisition unit 510 acquires document information (step S500).

In a case where the original document has been set in the ADF 51 (step S501: Yes), the procedure ends (transition to normal floating detection processing). In contrast, in a case where the original document is not set in the ADF 51 (step S501: No), the sensor correction unit 560 corrects the reference value of the floating detection sensor 200 to be 0 (step S502).

The sensor correction unit 560 may execute the correction processing as illustrated in FIG. 38A on a regular basis or in response to an instruction from the operator.

FIG. 38B is an example of a case where the sensitivity of the floating detection sensor 200 is corrected.

First, the number of fed sheets is acquired from the number of times the document set sensor 63 detects the original document (step S510).

Next, in a case where the difference from a normal value corresponding to the acquired number of fed sheets is small (step S511: Yes), the procedure ends. In contrast, in a case where the difference from the normal value corresponding to the acquired number of fed sheets is not small (step S511: No), the sensor correction unit 560 corrects the sensitivity of the floating detection sensor 200 (step S512).

The sensor correction unit 560 may execute the correction processing as illustrated in FIG. 38B for each document conveyance processing or in response to an instruction from the operator.

As described above, according to the present embodiment, the accuracy of the bound document detection processing can be maintained by performing calibration (correction processing) of the floating detection sensor 200.

### Sixth Embodiment

In a sixth embodiment, the ADF 51 includes multiple floating detection sensors 200. A binding position of the bound document is not often at the central position in a width direction (main-scanning direction) of the original document, and is often at a corner of a document bundle. For example, in a case where the floating detection sensor 200 is disposed in the vicinity of the center in the main-scanning direction, there is a case where detection of floating is delayed for a wide document bundle with bound corners, and the document bundle is damaged. In the present embodiment, the above disadvantage is prevented by arranging the multiple floating detection sensors 200 in the ADF 51. In the following description of the sixth embodiment, descriptions of elements overlapped with those in the first to fifth embodiments are omitted, and differences from the first to fifth embodiments are described.

FIG. 39 is a perspective view illustrating an example of the ADF 51 according to the fifth embodiment.

As illustrated in FIG. 39, the ADF 51 includes three floating detection sensors 200. The floating detection sensors 200 are disposed at the central position in the main-scanning direction and right and left positions in the main-scanning direction. By arranging the multiple floating detection sensors 200 in this manner, it is possible to accurately detect floating even in a case where there is the binding position at the corner of the wide document bundle.

As described above, according to the present embodiment, it is possible to detect the floating of the conveyance object according to multiple features of the conveyance object to be conveyed. By providing the multiple floating detection sensors 200, it is possible to improve the detection accuracy of whether the original document is the bound document.

Although some embodiments of the present disclosure have been described above, the above-described embodiments are presented as examples and are not intended to limit the scope of the present disclosure. The above-described novel embodiments can be implemented in other various forms, and various omissions, replacements, and changes can be made without departing from the scope of the present disclosure. Such novel embodiments and variations thereof are included in the scope and gist of the present disclosure and are included in the scope of the appended claims and the equivalent scope thereof. Further, configurations in different embodiments and modifications may be combined as appropriate.

In each of the above embodiments, an example has been described in which the image forming apparatus 100 is applied to a multifunction peripheral having at least two functions of a copy function, a printer function, a scanner function, and a facsimile function. However, the present invention can be applied to any device as long as the device conveys a conveyance object such as a document or a sheet, such as a copier, a printer, a scanner device, and a facsimile device.

The program executed by the image forming apparatus 100 of each embodiment described above is provided by being recorded in a computer-readable recording medium such as a CD-ROM, a flexible disk (FD), a CD-R, or a digital versatile disk (DVD) as a file in an installable format or an executable format.

The program to be executed in the image forming apparatus 100 according to each embodiment may be stored on a computer connected to a network, such as the Internet, and may be downloaded through the network for provision. The program executed on the image forming apparatus 100 according to the present embodiment may be provided or distributed via a network such as the Internet.

The programs may be provided by being incorporated in advance in, for example, the ROM 552.

The program executed by the image forming apparatus 100 of each embodiment has a module configuration including each functional unit (conveyance object information acquisition unit 510 and detected distance determination unit 520) described above, and as actual hardware, the CPU (processor) reads and executes the program from the recording medium, so that each unit is loaded on the main storage device, and each functional unit is generated on the main storage device.

Each function of the embodiments described above can be implemented by one processing circuit or multiple processing circuits. The term “processing circuit” in the present specification includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit components arranged to perform the recited functions.

A description is given of some aspects of the present disclosure.

### Aspect 1

In Aspect 1, a conveying device includes a conveyor, a separator, a supplier, a sensor, a conveyance object information acquisition unit, and a detection distance determination unit. The conveyor conveys a conveyance object. The separator separates the conveyance object from a stacked bundle of conveyance objects. The supplier supplies the conveyance object to the conveyor. The sensor detects floating of the conveyance object by an operation of the separator. The conveyance object information acquisition unit acquires length information of the conveyance object and acquires at least one of width information, thickness information, conveyance speed information, and stacking amount information. The detection distance determination unit determines a detection distance used by the sensor to detect the floating of the conveyance object. The detection distance determination unit determines the detection distance based on the length information and at least one of the width information, the thickness information, the conveyance speed information, and the loading amount information acquired by the conveyance object information acquisition unit.

### Aspect 2

In Aspect 2, in the conveying device according to Aspect 1, the detection distance determination unit specifies the detection distance using a trained model after machine learning using training data in which conveyance object information acquired from the conveyance object information acquisition unit is associated with a given detection distance.

### Aspect 3

In Aspect 3, the conveying device according to Aspect 1 or 2 further includes a detection height determination unit that determines a detection height used by the sensor to detect the floating of the conveyance object. The detection height determination unit determines the detection height based on the length information and at least one of the width information, the thickness information, the conveyance speed information, and the stacking amount information acquired by the conveyance object information acquisition unit.

### Aspect 4

In Aspect 4, in the conveying device according to Aspect 3, the detection height determination unit specifies the detection height using a trained model after machine learning using training data in which conveyance object information acquired from the conveyance object information acquisition unit is associated with a given detection height.

### Aspect 5

In Aspect 5, the conveying device according to any one of Aspects 1 to 4 further includes a determination unit that determines whether a detection target detected by the sensor is the conveyance object based on time-series output information output by the sensor.

### Aspect 6

In Aspect 6, a conveying device includes a conveyor, a separator, a supplier, a sensor, a conveyance object information acquisition unit, and a communicator. The conveyor conveys a conveyance object. The separator separates the conveyance object from a stacked bundle of conveyance objects. The supplier supplies the conveyance object to the conveyor. The sensor detects floating of the conveyance object by an operation of the separator. The conveyance object information acquisition unit acquires length information of the conveyance object and acquires at least one of width information, thickness information, conveyance speed information, and stacking amount information. The communicator sends the information acquired by the conveyance object information acquisition unit to an external system, and receives at least any one of a detection distance and a detection height used by the sensor to detect the floating of the conveyance object from the external system. The external system determines the detection distance based on the length information and at least one of the width information, the thickness information, the conveyance speed information, and the stacking amount information acquired by the conveyance object information acquisition unit.

### Aspect 7

In Aspect 7, in the conveying device according to Aspect 6, the communicator sends time-series output information output by the sensor to the external system, and the external system further includes a determination unit that determines whether a detection target detected by the sensor is the conveyance object based on the time-series output information.

### Aspect 8

In Aspect 8, an image forming apparatus includes the conveying device according to any one of Aspects 1 to 7, and an image forming device that forms an image on the conveyance object conveyed by the conveying device.

### Aspect 9

In Aspect 9, an image forming apparatus includes a conveyor, a separator, a supplier, a sensor, a conveyance object information acquisition unit, a detection distance determination unit, and an image forming device. The conveyor that conveys a conveyance object. The separator separates the conveyance object from a loaded bundle of conveyance objects. The supplier supplies the conveyance object to the conveyance unit. The sensor detects floating of the conveyance object by an operation of the separation unit. The conveyance object information acquisition unit acquires length information of the conveyance object and acquires at least one of width information, thickness information, conveyance speed information, and loading amount information. The detection distance determination unit determines a detection distance used by the detection unit to detect the floating of the conveyance object. The image forming device forms an image on the conveyance object supplied by the supply unit. The detection distance determination unit determines the detection distance based on the length information and at least one of the width information, the thickness information, the conveyance speed information, and the stacking amount information acquired by the conveyance object information acquisition unit.

### Aspect 10

In Aspect 10, a conveying method executed by a conveying device including a conveyor, a separator, a supplier, a sensor includes a conveyance object information acquisition step of acquiring length information of the conveyance object and acquiring at least one of width information, thickness information, conveyance speed information, and loading amount information, and a detection distance determination step of determining a detection distance used by the detection unit to detect the floating of the conveyance object. The conveyor conveys a conveyance object. The separator separates the conveyance object from a stacking bundle of conveyance objects. The supplier supplies the conveyance object to the conveyor. The sensor detects floating of the conveyance object by an operation of the separator. The detection distance determination step determines the detection distance based on the length information and at least one of the width information, the thickness information, the conveyance speed information, and the loading amount information acquired by the conveyance object information acquisition step.

### Aspect 11

In Aspect 11, a non-transitory recording medium storing a plurality of instructions which, when executed by one or more processors, causes the one or more processors to perform a method includes causing a computer to function as a conveyance object information acquisition unit that acquires length information of the conveyance object and acquires at least one of width information, thickness information, conveyance speed information, and loading amount information, and a detection distance determination unit that determines a detection distance used by the detection unit to detect floating of the conveyance object. The detection distance determination unit determines the detection distance based on the length information and at least one of the width information, the thickness information, the conveyance speed information, and the stacking amount information acquired by the conveyance object information acquisition unit, in a conveying device including a conveyor that conveys a conveyance object, a separator that separates the conveyance object from a stacked bundle of conveyance objects, a supplier that supplies the conveyance object to the conveyor, and a sensor that detects floating of the conveyance object by an operation of the separator.

### Aspect 12

In Aspect 12, a conveying device includes a conveyor, a separator, a supplier, a sensor, and circuitry. The conveyor conveys, at a conveyance speed, an object having a length, a width, and a thickness. The separator separates, in a separation process, the object from a stack of objects, including the object, stacked to a stacking amount. The supplier supplies the object to the conveyor. The sensor detects the object floated from the stack of objects in the separation process by the separator. The circuitry is to acquire the length, and at least one of the width, the thickness, the conveyance speed, or the stacking amount, determine a detection distance from the sensor to the object floated from the stack of objects based on the length, and at least one of the width, the thickness, the conveyance speed, and the stacking amount acquired, set the detection distance to the sensor to detect the object floated from the stack of objects, and detect the object floated from the stack of objects by the sensor set at the detection distance determined.

### Aspect 13

In Aspect 13, in the conveying device according to Aspect 12, the circuitry is further to generate a trained model by a machine learning based on training data including the length and at least one of the width, the thickness, the conveyance speed, and the stacking amount acquired, associated with the detection distance, to determine the detection distance.

### Aspect 14

In Aspect 14, the conveying device according to Aspect 12 or 13 further includes a loading tray to stack the stack of objects. The sensor detects the object floated from the stack of objects on the loading tray. The circuitry is further to determine a detection height from the sensor to the loading tray in a vertical direction, based on the length and at least one of the width, the thickness, the conveyance speed, and the stacking amount acquired.

### Aspect 15

In Aspect 15, in the conveying device according to Aspect 14, the circuitry is further to generate a trained model by a machine learning based on training data including the length and at least one of the width, the thickness, the conveyance speed, and the stacking amount acquired, associated with the detection height, to determine the detection height.

### Aspect 16

In Aspect 16, in the conveying device according to any one of Aspects 12 to 15, the circuitry is further to acquire the detection distance in time series from the sensor, and determine whether an object detected by the sensor is the object floated from the stack of objects, based on the detection distance acquired in time series.

### Aspect 17

In Aspect 17, an image forming apparatus includes the conveying device according to any one of Aspects 12 to 16, and an image forming device that forms an image on the conveyance object conveyed by the conveying device.

### Aspect 18

In Aspect 18, a conveying device includes a conveyor, a separator, a supplier, a sensor, circuitry, and a communicator. The conveyor conveys, at a conveyance speed, an object having a length, a width, and a thickness. The separator separates, in a separation process, the object from a stack of objects, including the object, stacked to a stacking amount. The supplier supplies the object to the conveyor. The sensor detects the object floated from the stack of objects in the separation process by the separator. The circuitry is to acquire information including the length, and at least one of the width, the thickness, the conveyance speed, or the stacking amount. The communicator sends the information acquired, to an external system, and receives, from the external system, at least one of a detection distance or a detection height to set the sensor to detect the object floated from the stack of objects. The external system determines at least one of the detection distance or the detection height based on the length and at least one of the width, the thickness, the conveyance speed, and the stacking amount acquired.

### Aspect 19

In Aspect 19, in the conveying device according to Aspect 17, the sensor detects the object in time series, the sensor set at the at least one of the detection distance or the detection height. The communicator sends a detection result of the object by the sensor in time series to an external system. The external system further includes another circuitry to determine whether the object detected by the sensor is the object floated from the stack of objects based on the detection result of the object by the sensor in time series.

### Aspect 20

In Aspect 20, an image forming apparatus includes a conveyor, a separator, a supplier, an image forming device, and circuitry. The conveyor conveys, at a conveyance speed, an object having a length, a width, and a thickness. The separator separates, in a separation process, the object from a stack of objects, including the object, stacked to a stacking amount. The supplier supplies the object to the conveyor. The image forming device forms an image on the object supplied by the supplier. The circuitry is to acquire the length, and at least one of the width, the thickness, the conveyance speed, or the stacking amount, determine a detection distance from a sensor to the object floated from the stack of objects based on the length, and at least one of the width, the thickness, the conveyance speed, and the stacking amount acquired, and determine the detection distance based on the length, and at least one of the width, the thickness, the conveyance speed, and the stacking amount acquired.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A conveying device comprising:
a conveyor to convey, at a conveyance speed, an object having a length, a width, and a thickness;
a separator to separate, in a separation process, the object from a stack of objects, including the object, stacked to a stacking amount;
a supplier to supply the object to the conveyor;
a sensor to detect the object floated from the stack of objects in the separation process by the separator; and
circuitry configured to:
acquire the length, and at least one of the width, the thickness, the conveyance speed, or the stacking amount;
determine a detection distance from the sensor to the object floated from the stack of objects based on the length, and at least one of the width, the thickness, the conveyance speed, and the stacking amount acquired;
set the detection distance to the sensor to detect the object floated from the stack of objects; and
detect the object floated from the stack of objects by the sensor set at the detection distance determined.

2. The conveying device according to claim 1,
wherein the circuitry is further configured to:
generate a trained model by a machine learning based on training data including:
the length and at least one of the width, the thickness, the conveyance speed, and the stacking amount acquired, associated with the detection distance,
to determine the detection distance.

3. The conveying device according to claim 1, further comprising:
a loading tray to stack the stack of objects,
wherein the sensor detects the object floated from the stack of objects on the loading tray,
the circuitry is further configured to:
determine a detection height from the sensor to the loading tray in a vertical direction,
based on the length and at least one of the width, the thickness, the conveyance speed, and the stacking amount acquired.

4. The conveying device according to claim 3,
wherein the circuitry is further configured to:
generate a trained model by a machine learning based on training data including:
the length and at least one of the width, the thickness, the conveyance speed, and the stacking amount acquired,
associated with the detection height,
to determine the detection height.

5. The conveying device according to claim 1,
wherein the circuitry is further configured to:
acquire the detection distance in time series from the sensor; and
determine whether an object detected by the sensor is the object floated from the stack of objects,
based on the detection distance acquired in time series.

6. An image forming apparatus comprising:
the conveying device according to claim 1; and
an image forming device to form an image on the object conveyed by the conveying device.

7. A conveying device comprising:
a conveyor to convey, at a conveyance speed, an object having a length, a width, and a thickness;
a separator to separate, in a separation process, the object from a stack of objects, including the object, stacked to a stacking amount;
a supplier to supply the object to the conveyor;
a sensor to detect the object floated from the stack of objects in the separation process by the separator;
circuitry configured to acquire information including the length, and at least one of the width, the thickness, the conveyance speed, or the stacking amount; and
a communicator to:
send the information acquired, to an external system; and
receive, from the external system, at least one of a detection distance or a detection height to set the sensor to detect the object floated from the stack of objects,
wherein the external system determines at least one of the detection distance or the detection height based on the length and at least one of the width, the thickness, the conveyance speed, and the stacking amount acquired.

8. The conveying device according to claim 7,
wherein the sensor detects the object in time series, the sensor set at the at least one of the detection distance or the detection height, and
the communicator sends a detection result of the object by the sensor in time series to an external system, and
the external system further includes another circuitry configured to determine whether the object detected by the sensor is the object floated from the stack of objects based on the detection result of the object by the sensor in time series.

9. An image forming apparatus comprising:
a conveyor to convey, at a conveyance speed, an object having a length, a width, and a thickness;
a separator to separate, in a separation process, the object from a stack of objects, including the object, stacked to a stacking amount;
a supplier to supply the object to the conveyor;
an image forming device that forms an image on the object supplied by the supplier; and
circuitry configured to:
acquire the length, and at least one of the width, the thickness, the conveyance speed, or the stacking amount;
determine a detection distance from a sensor to the object floated from the stack of objects based on the length, and at least one of the width, the thickness, the conveyance speed, and the stacking amount acquired; and
determine the detection distance based on the length, and at least one of the width, the thickness, the conveyance speed, and the stacking amount acquired.
